(19) United States
(12) Patent Application Publication
(10) Pub. No.: US 2026/0059188 A1
(43) Pub. Date: Feb. 26, 2026

(54) DETERMINING IMAGE-CAPTURE SETTINGS

(71) Applicant: QUALCOMM Incorporated, San Diego, CA (US)

(72) Inventors: Karthikeyan SHANMUGAVADIVELU, San Diego, CA (US); Viswesh PARAMESWARAN, San Diego, CA (US); Sandesh GHIMIRE, San Diego, CA (US); Hau HWANG, San Diego, CA (US); Shizhong LIU, San Diego, CA (US); Chinchuan CHIU, Poway, CA (US)

(21) Appl. No.: 19/305,660

(22) Filed: Aug. 20, 2025

Related U.S. Application Data
(60) Provisional application No. 63/687,212, filed on Aug. 26, 2024.

(51) Int. Cl. H04N 23/62; G06F 3/16; G06V 10/26; G06V 10/75; G06V 10/764; G10L 15/08; G10L 15/183; G10L 15/22; H04N 23/61; H04N 23/63; H04N 23/667

(52) U.S. Cl. CPC H04N 23/62; G10L 15/183; G10L 15/22; H04N 23/61; H04N 23/632; H04N 23/667; G06F 3/167; G06V 10/26; G06V 10/75; G06V 10/764; G10L 2015/088; G10L 2015/223

(57) ABSTRACT

Systems and techniques are described herein for capturing images. For instance, a method for capturing images is provided. The method may include obtaining a natural-language request from a user; determining one or more keywords based on the natural-language request; and adjusting at least one of image-capture settings or image-processing settings of an image-capture device based on the one or more keywords.

### CROSS-REFERENCE TO RELATED APPLICATIONS

This application claims the benefit of U.S. Provisional Application No. 63/687,212, filed Aug. 26, 2024, which is incorporated herein by reference in its entirety.

### TECHNICAL FIELD

The present disclosure generally relates to capturing image data. For example, aspects of the present disclosure include systems and techniques for determining image-capture settings and/or image-processing settings for capturing and/or processing images.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for processing of a captured image, such as alterations to contrast, brightness, saturation, sharpness, levels, curves, and colors, among others. Additionally, a camera may apply various techniques to modify captured images, such as noise-reduction techniques, high-dynamic-resolution techniques, super-resolution techniques, artificial-bokeh techniques, and panorama techniques.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for capturing images. According to at least one example, a method is provided for capturing images. The method includes: obtaining a natural-language request from a user; determining one or more keywords based on the natural-language request; and adjusting at least one of image-capture settings or image-processing settings of an image-capture device based on the one or more keywords.

In another example, an apparatus for capturing images is provided that includes at least one memory and at least one processor (e.g., configured in circuitry) coupled to the at least one memory. The at least one processor configured to: obtain a natural-language request from a user; determine one or more keywords based on the natural-language request; and adjust at least one of image-capture settings or image-processing settings of an image-capture device based on the one or more keywords.

In another example, a non-transitory computer-readable medium is provided that has stored thereon instructions that, when executed by one or more processors, cause the one or more processors to: obtain a natural-language request from a user; determine one or more keywords based on the natural-language request; and adjust at least one of image-capture settings or image-processing settings of an image-capture device based on the one or more keywords.

In another example, an apparatus for capturing images is provided. The apparatus includes: means for obtaining a natural-language request from a user; means for determining one or more keywords based on the natural-language request; and means for adjusting at least one of image-capture settings or image-processing settings of an image-capture device based on the one or more keywords.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IOT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example architecture of an image-processing system, according to various aspects of the present disclosure;

FIG. 2A is a block diagram illustrating an example system for capturing image data, according to various aspects of the present disclosure;

FIG. 2B is a block diagram illustrating an example system for capturing image data, according to various aspects of the present disclosure;

FIG. 3 is a block diagram including an example implementation of the adjustment determiner of FIG. 2A, according to various aspects of the present disclosure;

FIG. 4 is a block diagram illustrating example operations that may be implemented by the image signal processor (ISP) of FIG. 2A, according to various aspects of the present disclosure;

FIG. 5 is a block diagram illustrating an example system including a small language model (SLM) for generating keywords based on a natural-language request, according to various aspects of the present disclosure;

FIG. 6 is a block diagram illustrating stages in an example process of training a SLM to generate keywords based on natural-language requests, according to various aspects of the present disclosure;

FIG. 7 includes two block diagram illustrating two example processes for generating training data using a large language model (LLM), according to various aspects of the present disclosure;

FIG. 8 is a block diagram illustrating an example system including an LLM for generating keywords based on a natural-language request, according to various aspects of the present disclosure;

FIG. 9 is a block diagram illustrating another example system including an LLM for generating keywords based on a natural-language request, according to various aspects of the present disclosure;

FIG. 10 is a block diagram illustrating an example system including vision language model (VLM) for generating keywords based on a natural-language request, according to various aspects of the present disclosure;

FIG. 11 is a block diagram illustrating another example system for capturing images, according to various aspects of the present disclosure;

FIG. 12 is a block diagram illustrating another example system for capturing images, according to various aspects of the present disclosure;

FIG. 13 is a flow diagram illustrating an example process for capturing images, in accordance with aspects of the present disclosure;

FIG. 14 is a flow diagram illustrating another example process for capturing images, in accordance with aspects of the present disclosure;

FIG. 15 is a flow diagram illustrating yet another example process for capturing images, in accordance with aspects of the present disclosure;

FIG. 16 is a flow diagram illustrating yet another example process for capturing images, in accordance with aspects of the present disclosure;

FIG. 17 is a flow diagram illustrating yet another example process for capturing images, in accordance with aspects of the present disclosure;

FIG. 18 is a flow diagram illustrating yet another example process for capturing images, in accordance with aspects of the present disclosure;

FIG. 19 is a flow diagram illustrating yet another example process for capturing images, in accordance with aspects of the present disclosure;

FIG. 20 is a block diagram illustrating an example of a deep learning neural network that can be used to perform various tasks, according to some aspects of the disclosed technology;

FIG. 21 is a block diagram illustrating an example of a convolutional neural network (CNN), according to various aspects of the present disclosure;

FIG. 22 is a block diagram of an example transformer in accordance with some aspects of the disclosure; and

FIG. 23 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Electronic devices (e.g., mobile phones, wearable devices (e.g., smart watches, smart glasses, etc.), tablet computers, extended reality (XR) devices (e.g., virtual reality (VR) devices, augmented reality (AR) devices, mixed reality (MR) devices, and the like), connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an image signal processor (ISP) of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

In photography, the term “exposure,” relating to an image captured by a camera, refers to the amount of light per unit area that reaches a photographic film, or in modern cameras, an electronic image sensor (e.g., including an array of photodiodes). The exposure is based on certain image-capture settings such as, for example, exposure time, and/or lens aperture, as well as the luminance of the scene being photographed. Because of the relationship between the amount of light that reaches an image sensor and the duration of time the image sensors is allowed to capture the light, in the present disclosure, the terms “exposure,” “exposure duration,” and “exposure time” may refer to a duration of time during which the electronic image sensor is exposed to light (e.g., while the electronic image sensor is capturing an image) and/or an amount of time during which light reaching an image sensor is recorded as a single image frame.

Many cameras are equipped with an automatic exposure or “auto exposure” mode, where the image-capture settings (e.g., exposure time, lens aperture, etc.) of the camera may be automatically adjusted to match, as closely as possible, the luminance of a scene or subject being photographed. In some cases, an automatic exposure control (AEC) engine can perform AEC to determine image-capture settings for an image sensor. An AEC engine may seek to limit a number of pixels in an image frame that are overexposed and a number of pixels in an image frame that are underexposed. For example, an AEC engine may examine a first image, and determine image-capture settings for a subsequent image based on the exposure of the first image. For example, when a camera is capturing video data, the AEC engine may examine each frame and determine image-capture settings for each frame based on the exposure of the preceding frames. As another example, a camera may capture test frames (which may be displayed, for example, as preview frames to a user as they are composing a shot), and the AEC engine may determine image-capture settings based on the exposure of test frames.

In photography and videography, a technique called high dynamic range (HDR) allows the dynamic range of image frames captured by a camera to be increased beyond the native capability of the camera. In this context, the term “dynamic range” refers to the range of luminosity between the brightest area and the darkest area of the scene or image frame. For example, a high dynamic range means there is large variation in light levels within a scene or an image frame. HDR can involve capturing multiple image frames of a scene with different exposures and combining captured image frames into a single image frame. The combination of image frames with different exposures can result in an image with a dynamic range higher than that of each individual image frame captured and combined to form the HDR image frame. For example, the electronic device can create a high dynamic image frame by combining two or more image frames with different exposures into a single frame. HDR is a feature often used by electronic devices, such as smartphones and mobile devices, for various purposes. For example, in some cases, a smartphone can use HDR to achieve a better image quality or an image quality similar to the image quality achieved by a digital single-lens reflex (DSLR) camera.

In the present disclosure, the term “combine,” and like terms, with reference to images or image data, may refer to any suitable techniques for using information (e.g., pixels) from two or more images to generate an image (e.g., a “composite” image). For example, pixels from a first image and pixels from a second image may be combined to generate a composite image. In such cases some of the pixels of the composite image may be from the first image and others of the pixels of the composite image may be from the second image. In some cases, some of the pixels from the first image and the second image may be merged, fused, or blended. For example, color and/or intensity values for pixels of the composite image may be based on respective pixels from both the first image and the second image. For instance, a given pixel of the composite image may be based on an average, or a weighted average, between a corresponding pixel of the first image and a corresponding pixel of the second image (e.g., the corresponding pixels of the first image and the second image may be blended). As one example, a central region of a first image may be included in a composite image. Further, an outer region of a second image may be included in the composite image. Pixels surrounding the central region in the composite image may be based on weighted averages between corresponding pixels of the first image and corresponding pixels of the second image. In other words, pixels of the first image surrounding the central region may be merged, fused, or blended with pixels of the second image inside the outer region.

Image-capture settings may determine how image data is captured. Image-capture settings include, as examples, a selection of lens (e.g., a selection of a telephoto lens, a wide-angle lens, an ultra-wide-angle lens, a front-device lens, a back-device lens), a zoom setting, a focus setting, an exposure duration, an aperture size, an ISO and gain settings (e.g., analog and digital gain settings). Image-capture settings may determine the appearance of images captured according to the image-capture settings. For example, images captured according to a longer exposure duration may be brighter than images captured according to a shorter exposure duration. It may be important to select the right image-capture settings to capture an image having the desired appearance.

Image-processing settings may be used to modify captured images. Image-processing settings include, as examples, an exposure settings (which may artificially brighten or darken a capture image), contrast settings, highlight settings, shadow settings, white-balance settings (which may alter the color of pixels in an image to set some pixels as white), intensity settings, saturation settings, sharpness setting, color settings, hue settings, and noise-reduction settings. Images captured according to any image-capture settings may be modified according to image-capture settings. Image-processing settings may determine the appearance of processed images. For example, boosting the contrast of an image may increase the light of some portions of the image and darken other portions of the image. It may be important to select the right image-processing settings to achieve an image having the desired appearance.

Image-modification techniques may be used to further modify images. Image-modification techniques include, as examples, noise-reduction techniques, high-dynamic-resolution techniques, super-resolution techniques, artificial-bokeh techniques, a subject-keeper technique, an eraser technique; and panorama techniques. Image-modification techniques may apply data not present in an originally-captured image data to modify image. For example, as described above, an HDR technique may generate a combined image based on two captured images. An artificial bokeh technique may blur portions of an image (e.g., background portions) while leaving other portions (e.g., foreground portions) unaltered. An eraser technique may, for example, remove an object from an image, filling in the space formerly occupied by the object with background pixels. A subject-keeper technique may, for example, preserve a subject, not removing, blurring, or otherwise altering the subject

Cameras also may also apply various features, such as a timer, a flash, image-stabilization, digital zoom, digital image-stabilization.

Cameras may be configured with a number of modes of operation (“modes”). Examples of modes include: a professional mode (e.g., which may capture image data in a raw format), a professional video mode, a food mode (e.g., which may apply a focus setting and/or select a lens), a panorama mode (e.g., which may use a wide-angle lens or ultra-wide angle lens and/or request that the user pan the camera while the camera captures multiple images of the scene to stitch together), a slow-motion mode (e.g., which may increase a frame-capture rate of the camera), a time-lapse mode (e.g., which may decrease a frame-capture rate of the camera), a portrait mode (e.g., which may apply specific white-balance settings among other things), a video-portrait mode, a director's-view mode, a single-take mode, or a moon-capture mode. Each mode may include respective image-capture settings, respective image-processing settings and/or be associated with respective image-modification techniques. For example, a “sport mode” may include a relatively short exposure duration. A relatively short exposure duration may be suitable for capturing images of moving object, for example, capturing light quickly before a subject moves too much. A camera in sport mode apply the short exposure duration. The sport mode may include an initial exposure duration and/or a range of exposure durations. An AEC engine may adjust the exposure duration over time and/or based on a luminance of a scene while the camera is in sport mode. As another example, a “dark mode” or a “night mode” may include a relatively long exposure duration. A relatively long exposure duration may be suitable to capture images of dark scenes, for example, capturing light over a relatively long duration to brighten an image of the dark scene.

The options (e.g., image-capture settings, image-processing settings, image-modification techniques, features, and modes) provided by cameras may be overwhelming to a user. For example, it may require interest and effort to capture an optimal picture or video output for a scene. A user may want to simply enjoy the moment and record the moment. The user may not be interested in fiddling with the various options. As a result, a majority of pictures and videos captured by users may not benefit from the features and the flexibility offered by cameras.

Systems, apparatuses, methods (also referred to as processes), and computer-readable media (collectively referred to herein as “systems and techniques”) are described herein for capturing images. For example, the systems and techniques described herein may obtain a natural-language request from a user of a camera and determine image-processing settings and/or image-processing settings for capturing images based on the natural-language request. The systems and techniques may apply the image-capture settings and/or image-processing settings. Additionally, the systems and techniques may activate or apply image-modification techniques and/or features of the camera based on the natural-language request.

The systems and techniques may seek to understand the user (and the intent of the user) rather than expecting the user to understand the camera. The systems and techniques may include a natural-language interface. The user may describe his/her intentions and/or preferences as they would to a fellow human. The systems and techniques may then map the user's intentions to specific camera mode(s), image-capture settings, image-processing settings, and/or image-modification techniques. Then the systems and techniques may adjust the image-capture settings, the image-processing settings, and/or parameters of the image-modification techniques of the camera according to the mapping. Additionally, the systems and techniques may activate or apply image-modification techniques and/or features of the camera based on the mapping.

In the present disclosure, the term “request” may refer to a request, a query, an instruction, a command, or the like. In the present disclosure, the term “natural language” may indicate language that is natural to a speaker of the natural language. For example, a natural-language request may be a request made without effort to rephrase or reword the request to be understood by non-human hearer. For instance, a natural-language request may be worded and phrased as one would speak to another person.

Various aspects of the application will be described with respect to the figures below.

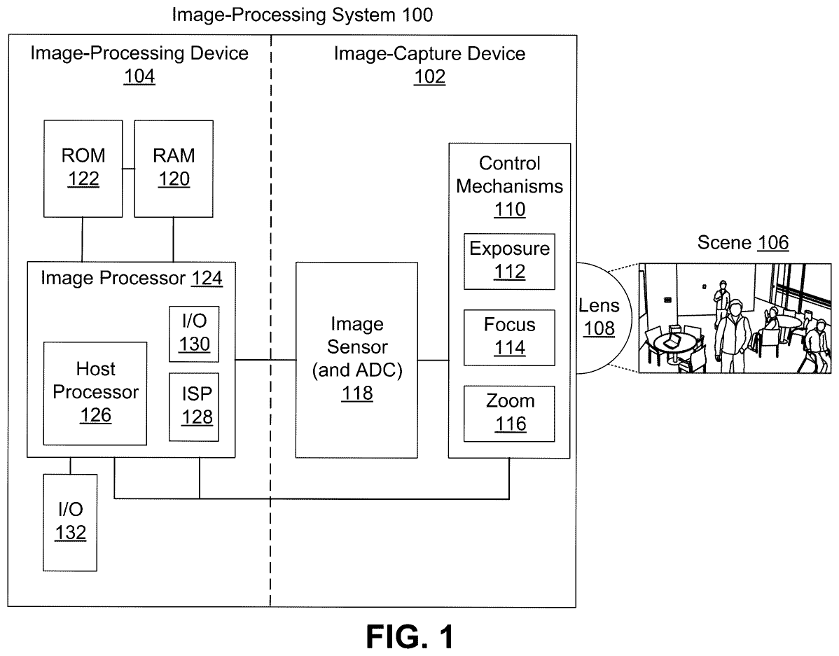

FIG. 1 is a block diagram illustrating an example architecture of an image-processing system 100, according to various aspects of the present disclosure. The image-processing system 100 includes various components that are used to capture and process images, such as an image of a scene 106. The image-processing system 100 can capture image frames (e.g., still images or video frames). In some cases, the lens 108 and image sensor 118 (which may include an analog-to-digital converter (ADC)) can be associated with an optical axis. In one illustrative example, the photosensitive area of the image sensor 118 (e.g., the photodiodes) and the lens 108 can both be centered on the optical axis.

In some examples, the lens 108 of the image-processing system 100 faces a scene 106 and receives light from the scene 106. The lens 108 bends incoming light from the scene toward the image sensor 118. The light received by the lens 108 then passes through an aperture of the image-processing system 100. In some cases, the aperture (e.g., the aperture size) is controlled by one or more control mechanisms 110. In other cases, the aperture can have a fixed size.

The one or more control mechanisms 110 can control exposure, focus, and/or zoom based on information from the image sensor 118 and/or information from the image processor 124. In some cases, the one or more control mechanisms 110 can include multiple mechanisms and components. For example, the control mechanisms 110 can include one or more exposure-control mechanisms 112, one or more focus-control mechanisms 114, and/or one or more zoom-control mechanisms 116. The one or more control mechanisms 110 may also include additional control mechanisms besides those illustrated in FIG. 1. For example, in some cases, the one or more control mechanisms 110 can include control mechanisms for controlling analog gain, flash, HDR, depth of field, and/or other image capture properties.

The focus-control mechanism 114 of the control mechanisms 110 can obtain a focus setting. In some examples, focus-control mechanism 114 stores the focus setting in a memory register. Based on the focus setting, the focus-control mechanism 114 can adjust the position of the lens 108 relative to the position of the image sensor 118. For example, based on the focus setting, the focus-control mechanism 114 can move the lens 108 closer to the image sensor 118 or farther from the image sensor 118 by actuating a motor or servo (or other lens mechanism), thereby adjusting the focus. In some cases, additional lenses may be included in the image-processing system 100. For example, the image-processing system 100 can include one or more microlenses over each photodiode of the image sensor 118. The microlenses can each bend the light received from the lens 108 toward the corresponding photodiode before the light reaches the photodiode.

In some examples, the focus setting may be determined via contrast detection autofocus (CDAF), phase detection autofocus (PDAF), hybrid autofocus (HAF), or some combination thereof. The focus setting may be determined using the control mechanism 110, the image sensor 118, and/or the image processor 124. The focus setting may be referred to as an image capture setting and/or an image processing setting. In some cases, the lens 108 can be fixed relative to the image sensor and the focus-control mechanism 114.

The exposure-control mechanism 112 of the control mechanisms 110 can obtain an exposure setting. In some cases, the exposure-control mechanism 112 stores the exposure setting in a memory register. Based on the exposure setting, the exposure-control mechanism 112 can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 118 (e.g., ISO speed or film speed), analog gain applied by the image sensor 118, or any combination thereof. The exposure setting may be referred to as an image capture setting and/or an image processing setting.

The zoom-control mechanism 116 of the control mechanisms 110 can obtain a zoom setting. In some examples, the zoom-control mechanism 116 stores the zoom setting in a memory register. Based on the zoom setting, the zoom-control mechanism 116 can control a focal length of an assembly of lens elements (lens assembly) that includes the lens 108 and one or more additional lenses. For example, the zoom-control mechanism 116 can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 108 in some cases) that receives the light from the scene 106 first, with the light then passing through a focal zoom system between the focusing lens (e.g., lens 108) and the image sensor 118 before the light reaches the image sensor 118. The focal zoom system may, in some cases, include two positive (e.g., converging, convex) lenses of equal or similar focal length (e.g., within a threshold difference of one another) with a negative (e.g., diverging, concave) lens between them. In some cases, the zoom-control mechanism 116 moves one or more of the lenses in the focal zoom system, such as the negative lens and one or both of the positive lenses. In some cases, zoom-control mechanism 116 can control the zoom by capturing an image from an image sensor of a plurality of image sensors (e.g., including image sensor 118) with a zoom corresponding to the zoom setting. For example, the image-processing system 100 can include a wide-angle image sensor with a relatively low zoom and a telephoto image sensor with a greater zoom. In some cases, based on the selected zoom setting, the zoom-control mechanism 116 can capture images from a corresponding sensor.

The image sensor 118 includes one or more arrays of photodiodes or other photosensitive elements. Each photodiode measures an amount of light that eventually corresponds to a particular pixel in the image produced by the image sensor 118. In some cases, different photodiodes may be covered by different filters. In some cases, different photodiodes can be covered in color filters, and may thus measure light matching the color of the filter covering the photodiode. Various color filter arrays can be used such as, for example and without limitation, a Bayer color filter array, a quad color filter array (QCFA), and/or any other color filter array.

In some cases, the image sensor 118 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an infrared (IR) cut filter, an ultraviolet (UV) cut filter, a band-pass filter, low-pass filter, high-pass filter, or the like). The image sensor 118 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 110 may be included instead or additionally in the image sensor 118. The image sensor 118 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

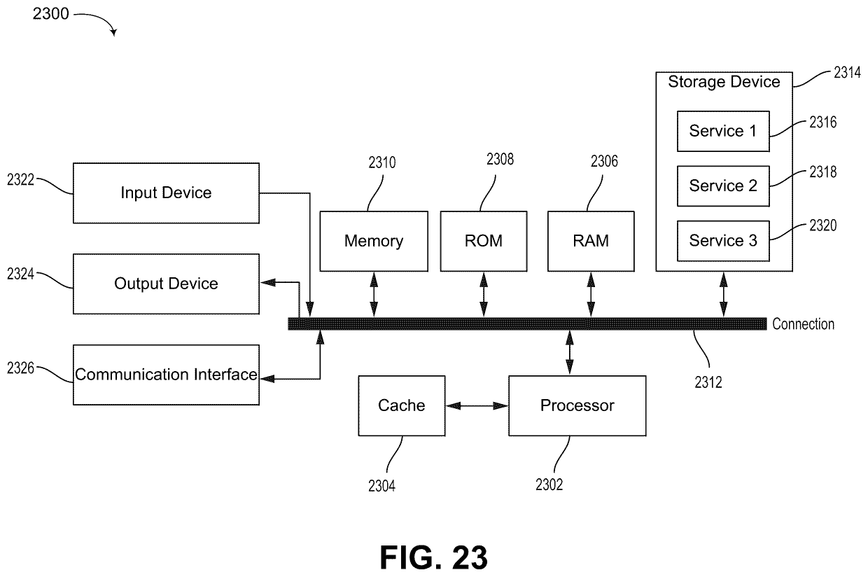

The image processor 124 may include one or more processors, such as one or more image signal processors (ISPs) (including ISP 128), one or more host processors (including host processor 126), and/or one or more of any other type of processor discussed with respect to the computing-device architecture 2200 of FIG. 23. The host processor 126 can be a digital signal processor (DSP) and/or other type of processor. In some implementations, the image processor 124 is a single integrated circuit or chip (e.g., referred to as a system-on-chip or SoC) that includes the host processor 126 and the ISP 128. In some cases, the chip can also include one or more input/output ports (e.g., input/output (I/O) ports 130), central processing units (CPUs), graphics processing units (GPUs), broadband modems (e.g., third generation (3G), fourth generation (4G) or long-term evolution (LTE), fifth generation (5G), etc.), memory, connectivity components (e.g., Bluetooth™, Global Positioning System (GPS), etc.), any combination thereof, and/or other components. The I/O ports 130 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General-Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 126 can communicate with the image sensor 118 using an I2C port, and the ISP 128 can communicate with the image sensor 118 using an MIPI port.

The image processor 124 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 124 may store image frames and/or processed images in random-access memory (RAM) 120, read-only memory (ROM) 122, a cache, a memory unit, another storage device, or some combination thereof.

Various input/output (I/O) devices 132 may be connected to the image processor 124. The I/O devices 132 can include a display screen, a keyboard, a keypad, a touchscreen, a trackpad, a touch-sensitive surface, a printer, any other output devices, any other input devices, or any combination thereof. In some cases, a caption may be input into the image-processing device 104 through a physical keyboard or keypad of the I/O devices 132, or through a virtual keyboard or keypad of a touchscreen of the I/O devices 132. The I/O devices 132 may include one or more ports, jacks, or other connectors that enable a wired connection between the image-processing system 100 and one or more peripheral devices, over which the image-processing system 100 may receive data from the one or more peripheral device and/or transmit data to the one or more peripheral devices. The I/O devices 132 may include one or more wireless transceivers that enable a wireless connection between the image-processing system 100 and one or more peripheral devices, over which the image-processing system 100 may receive data from the one or more peripheral device and/or transmit data to the one or more peripheral devices. The peripheral devices may include any of the previously-discussed types of the I/O devices 132 and may themselves be considered I/O devices 132 once they are coupled to the ports, jacks, wireless transceivers, or other wired and/or wireless connectors.

In some cases, the image-processing system 100 may be a single device. In some cases, the image-processing system 100 may be two or more separate devices, including an image-capture device 102 (e.g., a camera) and an image-processing device 104 (e.g., a computing device coupled to the camera). In some implementations, the image-capture device 102 and the image-capture device 102 may be coupled together, for example via one or more wires, cables, or other electrical connectors, and/or wirelessly via one or more wireless transceivers. In some implementations, the image-capture device 102 and the image-processing device 104 may be disconnected from one another.

As shown in FIG. 1, a vertical dashed line divides the image-processing system 100 of FIG. 1 into two portions that represent the image-capture device 102 and the image-processing device 104, respectively. The image-capture device 102 includes the lens 108, control mechanisms 110, and the image sensor 118. The image-processing device 104 includes the image processor 124 (including the ISP 128 and the host processor 126), the RAM 120, the ROM 122, and the I/O device 132. In some cases, certain components illustrated in the image-capture device 102, such as the ISP 128 and/or the host processor 126, may be included in the image-capture device 102. In some examples, the image-processing system 100 can include one or more wireless transceivers for wireless communications, such as cellular network communications, 802.11 wi-fi communications, wireless local area network (WLAN) communications, or some combination thereof.

The image-processing system 100 can be part of, or implemented by, a single computing device or multiple computing devices. In some examples, the image-processing system 100 can be part of an electronic device (or devices) such as a camera system (e.g., a digital camera, an internet protocol (IP) camera, a video camera, a security camera, etc.), a telephone system (e.g., a smartphone, a cellular telephone, a conferencing system, etc.), a laptop or notebook computer, a tablet computer, a set-top box, a smart television, a display device, a game console, an XR device (e.g., an head-mounted device (HMD), smart glasses, etc.), an IoT (Internet-of-Things) device, a smart wearable device, a video streaming device, an Internet Protocol (IP) camera, or any other suitable electronic device(s).

While the image-processing system 100 is shown to include certain components, one of ordinary skill will appreciate that the image-processing system 100 can include more components than those shown in FIG. 1. The components of the image-processing system 100 can include software, hardware, or one or more combinations of software and hardware. For example, in some implementations, the components of the image-processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image-processing system 100.

In some examples, the computing-device architecture 2300 shown in FIG. 23 and further described below can include the image-processing system 100, the image-capture device 102, the image-processing device 104, or a combination thereof.

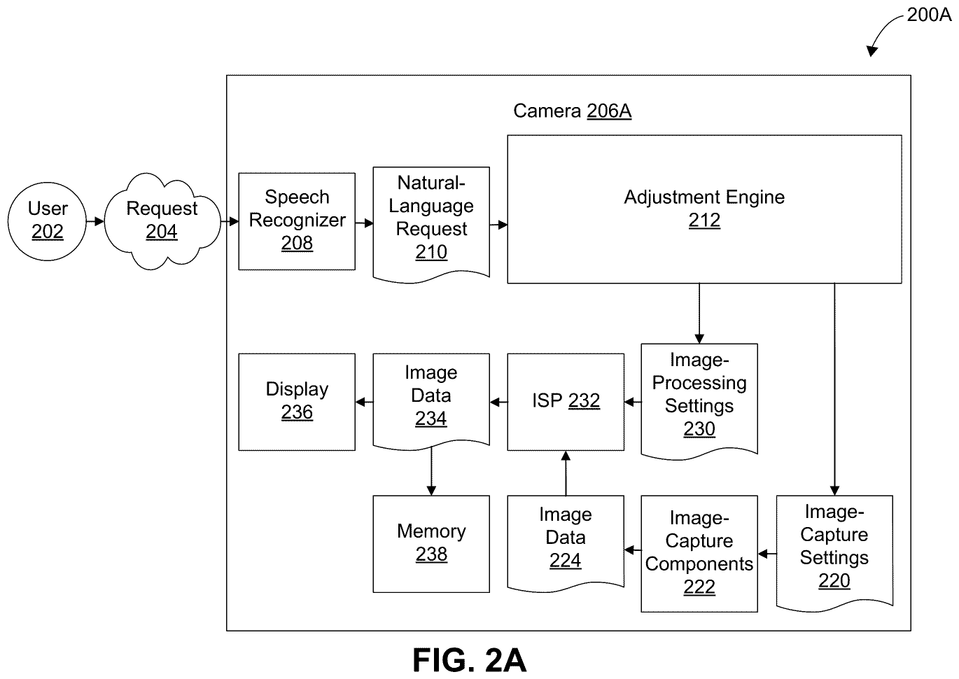

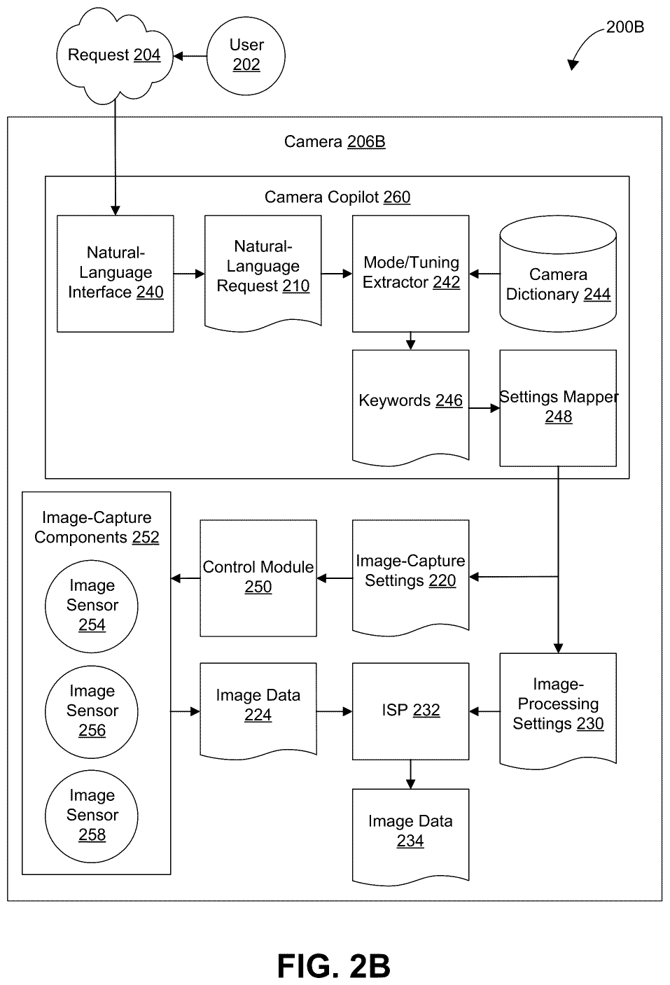

FIG. 2A is a block diagram illustrating an example system 200A for capturing image data, according to various aspects of the present disclosure. In general, a user 202 may speak a request 204. A speech recognizer 208 may process the spoken request 204 to generate natural-language request 210 (which may be a digital representation of request 204). An adjustment determiner 212 may determine image-capture settings 220 and/or image-processing settings 230 based on natural-language request 210. Image-capture components 222 may capture image data 224 based on image-capture settings 220. An image-signal processor (ISP) 232 may process image data 224 based on image-processing settings 230 to generate image data 234. A display 236 of camera 206A may display image data 234 (e.g., to user 202). Additionally or alternatively, a memory 238 of camera 206A may store image data 234.

User 202 may be a user of camera 206A. Camera 206A may be, or may include, a camera or a device including a camera. Camera 206A may have any suitable form factor and/or may be included in any suitable device. For example, camera 206A may be, may include, or may be included in, a dedicated camera, a smartphone, an extended reality (XR) device (which may include a virtual-reality (VR) device, augmented-reality (AR) device, and/or mixed-reality (MR) device), a headset, a head-mounted display (HMD), smart glasses, or another device.

User 202 may provide request 204 to camera 206A. For example, user 202 may speak request 204. Request 204 may relate to one or more images that have been captured by camera 206A and/or to one or more images that may be captured by camera 206A. For example, camera 206A may display image data 234 at display 236. User 202 may view image data 234 at display 236 and generate request 204 based on image data 234 viewed by user 202 at display 236. For instance, user 202 may determine that an element of image data 234 is too dark, too bright, too red, and/or that image data 234 as a whole is too noisy, too dark, not bright enough, not vibrant enough. User 202 may speak request 204 indicating a desired change.

Camera 206A may generate image-processing settings 230 based on request 204 and modify image data 234 based on image-processing settings 230 such that image data 234 reflects the requested change. Additionally or alternatively, camera 206A may determine image-capture settings 220 and adjust how future image data is captured, such that future images reflect the requested change. Additionally or alternatively, user 202 may make request 204 without first observing image data 234 at display 236. For example, user 202 may make request 204 without having first activated a camera application of a device or the device may interpret request 204 as a request to activate a camera application and the device may respond by activating the camera application and initialize the camera application according to image-capture settings 220 and/or image-processing settings 230. For example, user 202 may speak request 204 to a digital assistant of their smart phone. The digital assistant may initialize adjustment determiner 212 to determine image-capture settings 220 and/or image-processing settings 230 based on request 204. Further, the device may activate the camera application according to the determined image-capture settings 220 and/or image-processing settings 230.

Request 204 may be a natural-language request, for example, spoken (or provided using another form of user interface, such as a keyboard or touch screen). In other words, request 204 may be phrased as user 202 would speak to a person. Request 204 may, or may not, include terms related to modes, image-capture settings, and/or image-capture settings. For example, the request may be “make the sky more blue.” Alternatively, the request may be “increase the saturation” or “apply HDR.” In some cases, user 202 may word or phrase request 204 to be understood by camera 206A.

Camera 206A may include a microphone which may capture request 204 as an audio signal and provide the audio signal to speech recognizer 208. Speech recognizer 208 may generate natural-language request 210 based on request 204. Natural-language request 210 may be a digital representation of request 204. Natural-language request 210 may be, or may include, a transcription of spoken words to text. Natural-language request 210 may be referred to as a natural-language request even in cases in which user 202 may phrase request 204 for camera 206A.

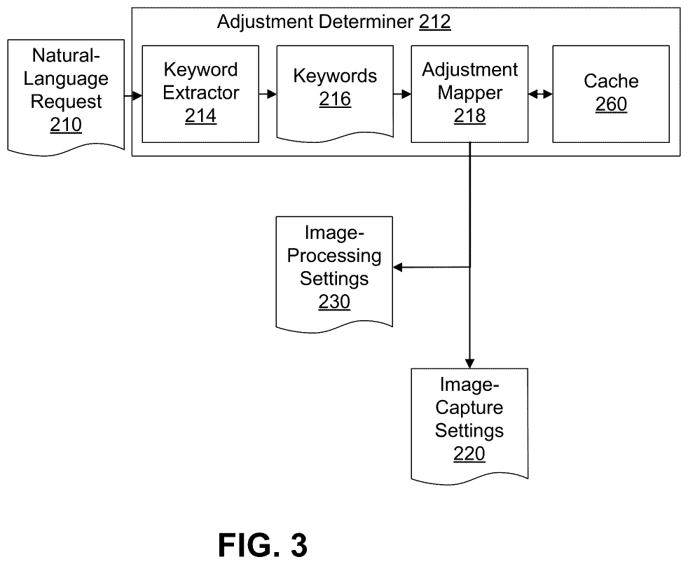

Adjustment determiner 212 may determine image-capture settings 220 and/or image-processing settings 230 based on natural-language request 210. FIG. 3 is a block diagram including an example implementation of adjustment determiner 212 of FIG. 2A, according to various aspects of the present disclosure. In general, a keyword extractor 214 of adjustment determiner 212 may determine keywords 216 based on natural-language request 210. An adjustment mapper 218 of adjustment determiner 212 may map keywords 216 to image-capture settings and image-processing settings of camera 206A and generate image-capture settings 220 and image-processing settings 230.

According to the example implementation of FIG. 3, adjustment determiner 212 is illustrated and described as including keyword extractor 214 and adjustment mapper 218 for descriptive purposes. In some aspects, adjustment determiner 212 may include keyword extractor 214 and adjustment mapper 218. In other aspects, adjustment determiner 212 may perform operations described with regard to keyword extractor 214 and adjustment mapper 218 in a single step, operation, model or module. For example, adjustment determiner 212 may determine image-capture settings 220 and/or image-processing settings 230 based on natural-language request 210.

Keyword extractor 214 may generate keywords 216 based on natural-language request 210. For example, keyword extractor 214 may extract keywords 216 from natural-language request 210. Keywords 216 may be, or may include, words indicative of or relevant to the desired change expressed by request 204. For example, natural-language request 210 may be “I want the sky to be bluer” and keywords 216 may be, or may include, “category: sky,” “saturation,” and “increase” or “category: sky,” “hue,” and “cooler.”

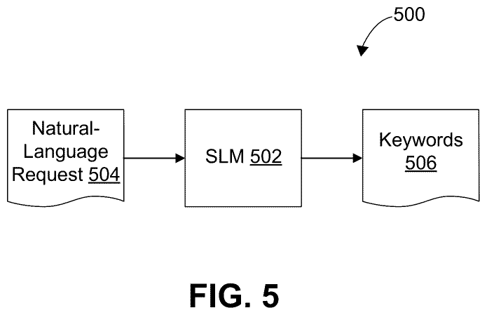

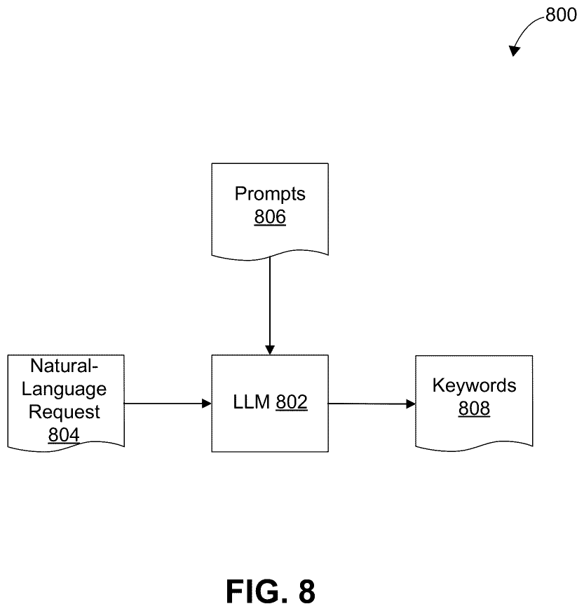

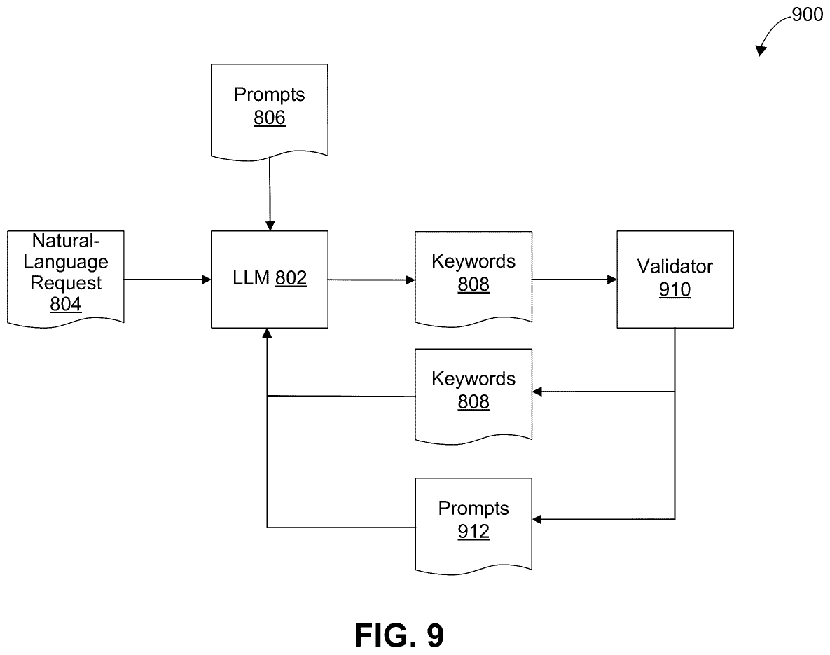

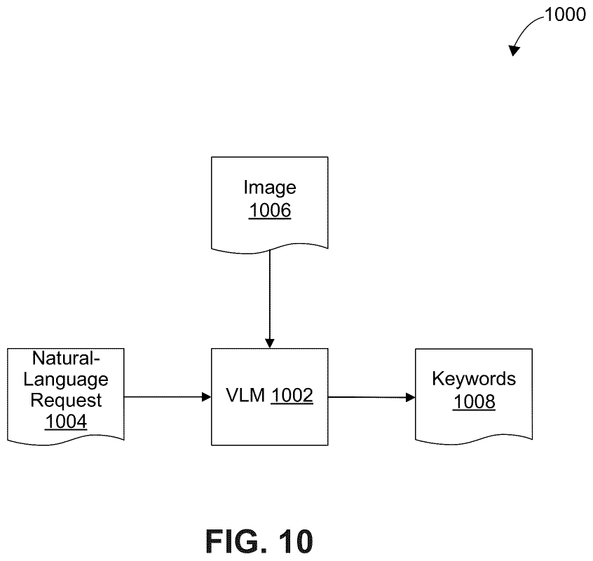

Keyword extractor 214 may be, or may include, a small language model, a large language model, and/or a vision language model. Keyword extractor 214 may be trained to extract keywords from natural-language requests. For example, keyword extractor 214 may be trained, through a supervised training process to generate keywords based on natural-language requests. Additional detail regarding examples of keyword extractor 214 are provided with regard to system 500 of FIG. 5, system 800 of FIG. 8, system 900 of FIG. 9, and system 1000 of FIG. 10.

Adjustment mapper 218 may map keywords 216 to image-capture settings 220 and/or image-processing settings 230 of camera 206A. For example, keywords 216 may be “category: sky,” “saturation,” and “increase.” Adjustment mapper 218 may determine a numerical value by which to increase the saturation and generate image-processing settings 230 including the numerical value along with an indication of “category: sky.” As another example, keywords 216 may be “category: sky,” “hue,” and “cooler.” Adjustment mapper 218 may determine a numerical value by which to change the hue and generate image-processing settings 230 including the numerical value along with an indication of “category: sky.” Adjustment mapper 218 may generate image-capture settings 220 and/or image-processing settings 230 according to application programming interfaces (APIs) of image-capture components 222 and/or ISP 232.

As another example, user 202 may use camera 206A to capture images of a dark scene. While capturing images, and viewing images (e.g., preview images) at display 236, user 202 may speak request 204 which may be “it's too dark, make it brighter.” Natural-language request 210 may be “it's too dark, make it brighter.” Keywords 216 may be “category: all,” “brightness,” and “increase.” Adjustment mapper 218 may determine how to make images captured by camera 206A brighter. For example, adjustment mapper 218 may determine to activate a “dark mode” which may be associated with image-capture settings 220 and/or image-processing settings 230 predetermined to be appropriate to increase the brightness of images. Additionally or alternatively, adjustment mapper 218 may determine to increase an exposure duration, a gain, and/or an ISO of image-capture settings 220 such that further images will be brighter. Additionally or alternatively, adjustment mapper 218 may determine to increase a brightness in post-processing and adjust a brightness setting in image-processing settings 230.

In some aspects, adjustment mapper 218 may determine image-capture settings 220 and/or image-processing settings 230 based on a predetermined mapping between image-capture settings 220, image-processing settings 230, and keywords. For example, keywords related to “blue” may be mapped to image-processing settings 230 related to “hue” and/or “white balance” and keywords related to “sharp” and “blurry” may be related to focus settings of image-capture settings 220 and/or sharpness settings of image-processing settings 230.

In some aspects, adjustment mapper 218 may determine image-capture settings 220 and/or image-processing settings 230 based, at least in part, on a mode of camera 206A, image data 224, and/or other data. For example, if camera 206A is in sport mode (either based on a user selection or based on a determination made by adjustment determiner 212 based on natural-language request 210), adjustment mapper 218 may seek to maintain a relatively low exposure duration. Thus, if keywords 216 is related to increasing brightness, adjustment mapper 218 may determine to increase brightness without increasing the exposure duration, for instance by increasing gain, ISO, or brightness settings in image-processing settings 230.

Image-capture settings 220 may be, or may include, a selection of a lens, a zoom setting, an exposure duration, an aperture size, a focus setting, an ISO, a gain setting, and/or other settings related to how image-capture components 222 may capture image data 224. Image-capture settings 220 may be formatted according to an API of image-capture components 222.

Image-processing settings 230 may be, or may include, an exposure setting, a contrast setting, a highlight setting, a shadow setting, a white-balance setting, an intensity setting, a saturation setting, a sharpness setting, color settings, hue settings, a noise-reduction setting and/or other settings related to how ISP 232 may process image data 224. Additionally, image-processing settings 230 may be, or may include, image-modification techniques and/or parameters for image-modification techniques. For example, image-processing settings 230 may be, or may include, instructions regarding application of (and/or parameters for) a noise-reduction technique, a high-dynamic resolution technique, a super-resolution technique, an artificial bokeh technique, a subject-keeper technique, an eraser technique, a panorama technique, and/or other techniques for modifying image data 224. Image-processing settings 230 may be formatted according to an API of ISP 232.

In some aspects, image-capture settings 220 and/or image-processing settings 230 may be selected based on a mode. For example, adjustment determiner 212 may determine a mode based on natural-language request 210. The mode may include one or more settings of image-capture settings 220 and/or image-processing settings 230. As such, by selecting a mode, adjustment determiner 212 may select the image-capture settings 220 and/or image-processing settings 230 associated with the mode. Examples of modes include an expert mode, a professional mode, a professional video mode, a night mode, a food mode, a panorama mode, a slow-motion mode, a time-lapse mode, a portrait mode, a video-portrait mode, a director's view mode, a single-take mode, a sport mode, and a moon-capture mode.

Returning to FIG. 2A, image-capture components 222 may capture image data 224 based on image-capture settings 220. Image-capture device 102 of FIG. 1 (including lens 108, control mechanism 110, exposure-control mechanism 112, focus-control mechanism 114, zoom-control mechanism 116, and image sensor 118) may be an example of image-capture components 222. For example, image-capture settings 220 may include an exposure duration and exposure-control mechanism 112 of control mechanism 110 may implement the exposure duration. Image data 224 may be, or may include, image data captured by image-capture components 222 according to image-capture settings 220.

ISP 232 may process image data 224 based on image-processing settings 230 to generate image data 234. For example, image-processing settings 230 may adjust image data 224 based on image-processing settings 230 and/or implement image-modification techniques according to image-processing settings 230.

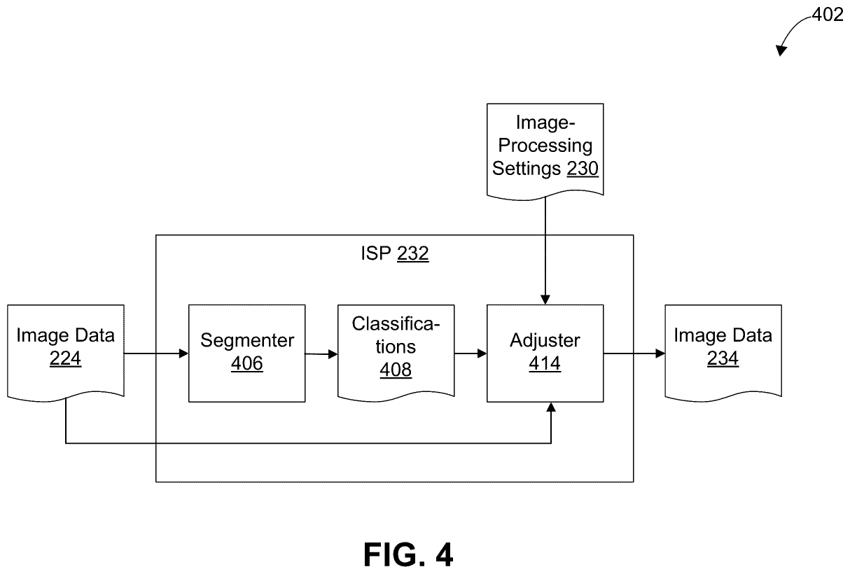

In some aspects, ISP 232 may be capable of segmented image processing. For example, ISP 232 may be capable of processing different portions of image data 224 differently. FIG. 4 is a block diagram illustrating example operations that may be implemented by ISP 232 of FIG. 2A, according to various aspects of the present disclosure. In general, a segmenter 406 of ISP 232 may determine classifications 408 of pixels of image data 224 and an adjuster 414 may adjust pixels of image data 224 based on classifications 408 and image-processing settings 230.

Returning to FIG. 2A, segmenter 406 may be, or may include, an image-segmentation model that may classify pixels of image data 224 into different classes (such as, sky, grass, people, etc.) based on what is represented by the pixels. Classifications 408 may be, or may include, an association between pixels of image data 224 and various classes (which may be referred to as labels).

Adjuster 414 may process image data 224 based on an association between “categories” included in image-processing settings 230 and classes of classifications 408. For example, image-processing settings 230 may include a “category: sky.” Similarly, in some instances, classifications 408 may include a class “sky.” In such cases, adjuster 414 may adjust the pixels of image data 224 that are classified as “sky” according to image-processing settings 230.

Camera 206A may display image data 234 at display 236. Additionally or alternatively, camera 206A may store image data 234 in memory 238. Additionally or alternatively, camera 206A may transmit image data 234, for example, to be displayed or stored by another device.

In some aspects, image data 224 and image data 234 may be, or may include, preview image data, for example, captured prior to user 202 instructing camera 206A to capture an image (e.g., prior to user 202 pressing a shutter button). In such cases, image data 224 and image data 234 may include image data captured and processed prior to camera 206A receiving request 204 and prior to generating image-capture settings 220 and image-processing settings 230 based on natural-language request 210. Prior to receiving request 204, camera 206A may generate image-capture settings and/or image-processing settings in some other way, for example, based on an image-capture mode of camera 206A. Additionally, the preview image data may include image data capture after camera 206A has received request 204. For example, image data 224 and image data 234 may include image data captured according to image-capture settings 220 (which are generated based on natural-language request 210) and/or processed according to image-processing settings 230 (which are generated based on natural-language request 210).

Additionally, image data 224 and image data 234 may include image data captured in response to a user input. For example, image data 224 and image data 234 may be image data capture in response to user 202 instructing camera 206A to capture an image or a video.

In an example of contemplated operations of system 200A, user 202 may say (e.g., request 204 may be) “I want to record a close-up view of my son while he is playing soccer on the field.” Based on such a request, adjustment determiner 212 may generate image-capture settings 220 and image-processing settings 230 such that camera 206A uses object tracking (e.g., in ISP 232) to track the selected subject and uses a combination of optical and digital zoom to adaptively frame the subject (appropriately zoomed and centered). In responding to such a request 204, camera 206A may perform operations not easily accessible to a user. For example, camera 206A may be capable of tracking objects and zooming on a subject. But accomplishing these tasks may be time consuming and require user 202 to know how to access and use the tools to perform the tasks. However, because adjustment determiner 212 interprets the intent of user 202 (expressed as request 204), adjustment determiner 212 enables user 202 to instruct camera 206A to perform the operations simply. Further, user 202 may not be as capable of tracking their son and zooming in on their son when capturing video as camera 206A is able to. Adjustment determiner 212 may allow user 202 to leverage capabilities of camera 206A (such as object tracking) live, while capturing images or video.

As another example of contemplated operations of system 200A, user 202 may say “I want to take a photo of my daughter right when she hits the ball. I also want to record a slow-motion video of that moment.” Based on such a request, adjustment determiner 212 may generate image-capture settings 220 and image-processing settings 230 such that camera 206A activates video recording, activates zero shutter lag (last ‘N’ snapshot frames are queued in a circular buffer), identifies the desired moment of capture (‘bat makes contact with the ball’) based on scene analysis, encodes the snapshot frame corresponding to that moment, and automatically edits the video to preserve only the video segment around that moment. In responding to such a request 204, camera 206A may perform a combination of operations that is inaccessible to user 202. For example, camera 206A may, by default, allow a snapshot mode or a slow-motion video mode, but not both. Adjustment determiner 212 may expose modes of operation to user 202 that were not previously accessible. Additionally, camera 206A may be better able to time the capture of the snapshot than user 202 is. Adjustment determiner 212 may enable user 202 to leverage the image-analysis capabilities of camera 206A to capture the desired image. For example, adjustment determiner 212 may enable modes that are not practical in current user interface.

As yet another example of contemplated operations of system 200A, user 202 may say “I want to record videos from both front and back cameras at the same time for my vlog.” Based on such a request, adjustment determiner 212 may generate image-capture settings 220 and image-processing settings 230 such that camera 206A activates video capture from both rear and front cameras and records the video in a picture-in-picture fashion. In responding to such a request 204, camera 206A may perform a combination of operations that is inaccessible to user 202. For example, camera 206A may, by default, allow images and/or video to be captured from one of the lenses or cameras of camera 206A at a time. Adjustment determiner 212 may allow user 202 to instruct camera 206A to activate multiple lenses and/or cameras.

As yet another example of contemplated operations of system 200A, user 202 may say “the sky looks dull and cloudy. Make it vibrant and blue.” Based on such a request, adjustment determiner 212 may generate image-capture settings 220 and image-processing settings 230 such that camera 206A identifies the sky pixels using semantic segmentation and replaces cloudy sky with a clear blue sky. In responding to such a request 204, camera 206A may perform operations that are time-consuming and/or require special knowledge to use.

As yet another example of contemplated operations of system 200A, user 202 may say “I want capture a picture of my friend with the sunset in the background.” Based on such a request, adjustment determiner 212 may generate image-capture settings 220 and image-processing settings 230 such that camera 206A adjust exposure to preserve the details of the sunset and adjust tone-mapping to bring out the details on the foreground subject. Default camera exposure settings (e.g., selected by an AEC engine) tend to prioritize human subjects, which is likely to overexpose the background sunset. Responding to such a request 204 may involve overriding default settings of camera 206A.

As yet another example of contemplated operations of system 200A, user 202 may say “blur the clutter in the background.” Based on such a request, adjustment determiner 212 may generate image-capture settings 220 and image-processing settings 230 such that camera 206A activates bokeh mode. In responding to such a request, adjustment determiner 212 may enable user 202 to quickly and simply use settings and/or modes of camera 206A without having to have special knowledge of the settings and/or modes.

As yet another example of contemplated operations of system 200A, user 202 may say “I want to capture in black and white” Based on such a request, adjustment determiner 212 may generate image-capture settings 220 and image-processing settings 230 such that camera 206A adjusts tone mapping and color processing to generate grayscale picture.

As yet another example of contemplated operations of system 200A, user 202 may say “I want all the kids to smile and have their eyes open in my photo.” Based on such a request, adjustment determiner 212 may generate image-capture settings 220 and image-processing settings 230 such that camera 206A activates the ‘Smart Portrait’ feature. The Smart Portrait feature may capture a burst of frames, selects the frame with most optimal eye openness/smile for all of the subjects. The Smart Portrait feature may further combine elements from other frames to improve eye openness and smile.

As yet another example of contemplated operations of system 200A, user 202 may say “I want to take a selfie on a count of three.” Based on such a request, adjustment determiner 212 may generate image-capture settings 220 and image-processing settings 230 such that camera 206A switches to selfie camera, activates a 3-second timer, and vocalize the counting down.

As yet another example of contemplated operations of system 200A, user 202 may say “make the sky more colorful.” Based on such a request, adjustment determiner 212 may generate image-capture settings 220 and image-processing settings 230 such that camera 206A increases saturation strength for the sky category pixels in the ISP.

As yet another example of contemplated operations of system 200A, user 202 may say “make the face look warmer.” Based on such a request, adjustment determiner 212 may generate image-capture settings 220 and image-processing settings 230 such that camera 206A adjusts the hue of the skin category pixels towards warmer tone.

As yet another example of contemplated operations of system 200A, user 202 may say “my jacket should look more blue than green.” Based on such a request, adjustment determiner 212 may generate image-capture settings 220 and image-processing settings 230 such that camera 206A adjusts the hue of the clothes category pixels towards cooler tone.

As yet another example of contemplated operations of system 200A, user 202 may say “I would like to see more details on my sweater.” Based on such a request, adjustment determiner 212 may generate image-capture settings 220 and image-processing settings 230 such that camera 206A system 200A camera 206A increases the sharpening on the clothes category pixels.

In some cases, request 204 may be a single request. In other cases, request 204 may be one of several requests. Adjustment determiner 212 may accumulate adjustments to image-capture settings 220 and/or image-processing settings 230 based on receiving multiple requests.

For example, camera 206A may capture image data 224, process image data 224 according to a first instance of image-processing settings 230 (e.g., which may be based on a current mode of camera 206A) to generate a first instance of image data 234, and display the first instance of image data 234 at display 236. User 202 may observe the first instance of image data 234 at display 236 and say “change the tone of the sky.” In response, adjustment determiner 212 may determine a second instance of image-processing settings 230 and reprocess image data 224 (or the first instance of image data 234) according to the second instance of image-processing settings 230 to generate a second instance of image data 234 and display the second instance of image data 234 at display 236.

User 202 may observe the second instance of image data 234 and say “reduce the noise of the sky.” In response, adjustment determiner 212 may determine a third instance of image-processing settings 230. The third instance of image-processing settings 230 may be based on the first request (“change the tone of the sky”) and the second request (“reduce the noise of the sky”). The third instance of image-processing settings 230 may be determined to accomplish the intent of both requests. ISP 232 may reprocess the second instance of image data 234 (or process image data 224) according to the third instance of image-processing settings 230 to generate a third adjusted instance of image data 234 and camera 206A may display the third instance of image data 234 at display 236.

Adjustment determiner 212 may cumulatively generate image-processing settings 230. For example, when generating the third instance of image-processing settings 230, adjustment determiner 212 may make changes to the second instance of image-processing settings 230. For example, in response to the second request, adjustment determiner 212 may generate image-processing settings 230 to maintain the changes to the tone of the pixels representing the sky and to introduce additional changes to image-processing settings 230 to reduce noise in pixels representing the sky.

Additionally or alternatively, adjustment determiner 212 may determine image-capture settings 220 based on multiple requests 204. For example, camera 206A may capture a first instance of image data 224 according to a first instance of image-capture settings 220 (e.g., which may be based on autoexposure, autofocus and/or auto-white balance settings), process the first instance of image data 224 to generate a first instance of image data 234, and display the first instance of image data 234 at display 236. User 202 may observe the first instance of image data 234 at display 236 and say “change the tone of the sky.” In response, adjustment determiner 212 may determine a second instance of image-capture settings 220 and capture a second instance of image data 224 according to the second instance of image-capture settings 220. ISP 232 may process the second instance of image data 224 to generate a second instance of image data 234 and display the second instance of image data 234 at display 236.

User 202 may observe the second instance of image data 234 and say “reduce the noise of the sky.” In response, adjustment determiner 212 may determine a third instance of image-capture settings 220 and capture a third instance of image data 224 according to the third instance of image-capture settings 220. The third instance of image-capture settings 220 may be based on the first request (“change the tone of the sky”) and the second request (“reduce the noise of the sky”). The third instance of image-capture settings 220 may be determined to accomplish the intent of both requests. ISP 232 may reprocess the third instance of image data 224 to generate a third adjusted instance of image data 234 and camera 206A may display the third instance of image data 234 at display 236.

Adjustment determiner 212 may cumulatively generate image-processing settings 230. For example, when generating the third instance of image-processing settings 230, adjustment determiner 212 may make changes to the second instance of image-processing settings 230. For example, in response to the second request, adjustment determiner 212 may generate image-processing settings 230 to maintain the changes to the tone of the pixels representing the sky and to introduce additional changes to image-processing settings 230 to reduce noise in pixels representing the sky.

Adjustment determiner 212 may determine both image-capture settings 220 and image-processing settings 230 based on multiple requests. For example, camera 206A may capture several instances of image data 224 and adjustment determiner 212 may determine and/or update and apply image-capture settings 220 as new requests are received. Additionally, adjustment determiner 212 may determine and/or update image-processing settings 230 and apply image-processing settings 230 to instances of image data 224 as they are available. Additionally or alternatively, adjustment determiner 212 may apply new or updated image-processing settings 230 to previously-captured instances of image data 234.

In some aspects, adjustment determiner 212 may include a cache 260 that may store keywords, requests, and/or prior instances of image-capture settings 220 and/or image-processing settings 230 to allow the accumulation of image-capture settings 220 and/or image-processing settings 230. For example, adjustment mapper 218 may determine new instances of image-capture settings 220 and image-processing settings 230 based on newly-received instances of keywords 216 and based on prior instances of keywords, requests, image-capture settings, and/or image-processing settings stored in cache 260.

Adjustment determiner 212 may apply a timeout or other means of determining when to flush keywords, requests, image-capture settings, and/or image-processing settings stored in cache. For example, if user 202 deactivate a camera 206A or a camera application of camera 206A, adjustment determiner 212 may flush cache 260. As another example, if a scene changes, adjustment determiner 212 may flush cache 260.

In some aspects, keyword extractor 214 may be, or may include, a small language model trained specifically for generating keywords (e.g., in a specific format) based on natural-language requests. For example, FIG. 5 is a block diagram illustrating an example system 500 including a small language model (SLM) 502 for generating keywords 506 based on a natural-language request 504, according to various aspects of the present disclosure. SLM 502 may be an example of keyword extractor 214 of FIG. 2A, natural-language request 504 may be an example of natural-language request 210 of FIG. 2A, and keywords 506 may be an example of keywords 216 of FIG. 2A.

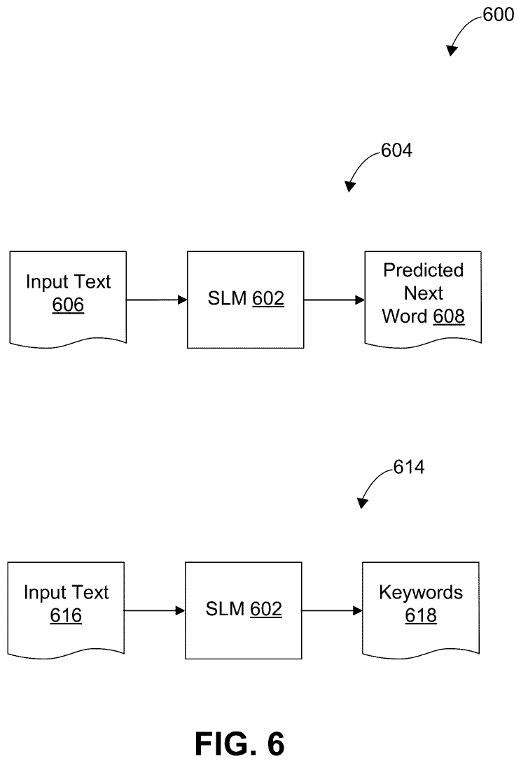

FIG. 6 is a block diagram illustrating stages in an example process 600 of training a small language model (SLM) 602 to generate keywords based on natural-language requests, according to various aspects of the present disclosure. SLM 602 may be an example of SLM 502 of FIG. 5.

For example, process 600 may include a pretraining stage 604 and a finetuning stage 614. During pretraining stage 604, SLM 602 may be trained to generate predicted next words 608 based on input text 606 through a supervised training procedure. For example, SLM 602 may be provided with an instance of input text 606 from a corpus of training data. SLM 602 may generate an instance of predicted next word 608 based on the instance of input text 606. A trainer may compare the instance of predicted next word 608 with the word following the instance of input text 606 in the training data. The trainer may determine an error (or loss) based on a difference between the instance of predicted next word 608 and the word following input text 606 in the training data. The trainer may adjust parameters (e.g., weights) of SLM 602 based on the error such that in further iterations of the training procedure, SLM 602 produces instance of predicted next word 608 that more closely resemble the words following instances of input text 606 through a gradient-descent process. The corpus of training data used during pretraining stage 604 may include general text, for example, text not specifically related to images or imaging. The ground-truth responses for a given training input may be the words following the training input.

During finetuning stage 614, SLM 602 may be finetuned to generate keywords 618. For example, once trained at pretraining stage 604, SLM 602 may be additionally trained (e.g., finetuned) to generate keywords 618 that include words from a set of words and/or that follow a format. For example, whereas during pretraining stage 604 SLM 602 may be trained to generate any word, at finetuning stage 614, SLM 602 may be trained to generate words from a list of words related to images and imaging. Further, SLM 602 may be trained to output the words in a specific format. For instance, SLM 602 may be trained to generate words (and to output the words in a format) so that adjustment mapper 218 can map the words to image-capture settings 220 and/or image-processing settings 230.

For example, SLM 602 may be provided with an instance of input text 616 from a corpus of training data. The corpus of training data used during finetuning stage 614 may include examples of requests (e.g., natural-language requests) to change images. SLM 602 may generate an instance of keywords 618 based on the instance of input text 616. A trainer may compare the instance of keywords 618 with keywords of the corpus of training data that correspond to the instance of input text 616. For example, the instance of input text 616 may be “increase the saturation of the sky.” That instance of input text 616 may correspond to a ground-truth output of “category: sky, saturation increase.” The trainer may determine an error (or loss) based on a difference between the instance of keywords 618 and the corresponding keyword in the corpus of training data. The trainer may adjust parameters (e.g., weights) of SLM 602 based on the error such that in further iterations of the training procedure, SLM 602 produces instance of keywords 618 that more closely resemble the keywords in the corpus of training data through a gradient-descent process.

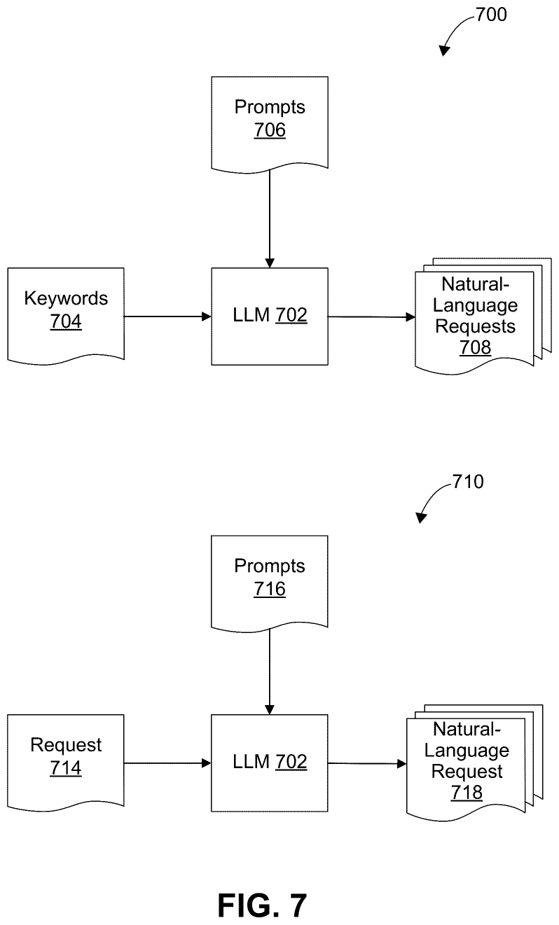

In some aspects, the corpus of training data used during finetuning stage 614 may be generated by a large language model. FIG. 7 includes two block diagram illustrating two example processes (process 700 and process 710) for generating training data (e.g., that may be used during finetuning stage 614 of process 600 of FIG. 6) using a large language model (LLM) 702, according to various aspects of the present disclosure.

For example, according to process 700, LLM 702 may generate natural-language requests 708 (e.g., natural-language requests) based on keywords 704 and prompts 706. LLM 702 may be, or may include, a large language model trained using general text based on input text. Additionally, LLM 702 may be trained to use prompts which may include contextual information, instructions, and/or examples.

Keywords 704 may be examples of keywords. Keywords 704 may correspond to text that adjustment mapper 218 may map to image-capture settings 220 and/or image-processing settings 230. Prompts 706 may be, or may include, instructions, contextual information, and/or examples that instruct LLM 702 to produce a number of various outputs (e.g., natural-language requests 708) based on keywords 704. natural-language requests 708 may be, or may include, a number of varied outputs based on keywords 704.

For example, keywords 704 may be “category: sky, saturation: increase” and two example instances of natural-language requests 708 are “increase saturation of sky” and “hey, the sky looks too bland. Is it possible to increase its color saturation?” As another example, keywords 704 may be “mode: high frame rate” and two example instances of natural-language requests 708 are “could you take a picture in slow-motion style?” and “yesterday, I saw a small clip of waterfall in a slow motion, it looked quite pretty. I want the same effect with my walking.”

According to process 710, LLM 702 may be generate natural-language request 718 (e.g., natural-language requests) based on request 714 (e.g., a natural-language request) and prompts 716. Request 714 may be a request to modify an image (or image-capture settings). Request 714 may be an example one of natural-language requests 708.

Prompts 716 may be, or may include, instructions, contextual information, and/or examples that instruct LLM 702 to produce a number of various outputs (e.g., natural-language request 718) based on request 714. Natural-language request 718 may be, or may include, a number of varied outputs based on request 714. For example, request 714 may be “The sky is bland. Increase the color.” and natural-language request 718 may include “Increase saturation of sky” and “make the sky more colorful.”

In some aspects, keyword extractor 214 may be, or may include, a large language model that may be used to generate keywords (e.g., in a specific format) based on natural-language requests. FIG. 8 is a block diagram illustrating an example system 800 including large language model (LLM) 802 for generating keywords 808 based on a natural-language request 804, according to various aspects of the present disclosure. LLM 802 may be an example of keyword extractor 214 of FIG. 2A, natural-language request 804 may be an example of natural-language request 210 of FIG. 2A, and keywords 808 may be an example of keywords 216 of FIG. 2A.

LLM 802 may be, or may include, a large language model trained using general text. Additionally, LLM 802 may be trained to use prompts which may include contextual information, instructions, and/or examples. For example, LLM 802 may be trained to generate outputs based on queries and based on provided contextual information. In other words, LLM 802 may be capable of in-context learning. In still other words, prompts 806 may be based on prompt engineering including contextual information, instructions, and/or examples that may improve the ability of keywords 808 to generate keywords 808.

Additionally or alternatively, LLM 802 may be trained to generate outputs based on instructions and/or following examples.

Prompts 806 may be, or may include, contextual information, for example, prompts 806 may include words related to images, colors, shapes, objects, imaging, cameras, image-capture settings, image-processing settings, image-modification techniques, and other topics. Prompts 806 may provide LLM 802 with context for generating keywords 808.

Additionally or alternatively, prompts 806 may be, or may include, instructions for generating keywords 808. For example, prompts 806 may include instructions regarding specific words and/or formatting to use when generating keywords 808. The specific words and formatting may be interpretable by adjustment mapper 218 as specific instructions and/or as relating to image-capture settings and/or image-processing settings. For example, prompts 806 may include text such as “We have following categories: pets, skin, sky, vegetation, flower, hair, clothes, person, all. Possible attributes are: saturation, noise, details and tone which take one of the following values: decrease, increase.”

Additionally or alternatively, prompts 806 may be, or may include, examples of natural-language requests and corresponding keywords. For example, prompts 806 may include text such as “Q: Perhaps because of low light, the noise in pet seems to be high. Reduce it significantly. A: ‘category’: ‘pets’, ‘noise’: ‘decrease’, ‘intensity’: ‘strong’ Q: Please tone down the sky. A: ‘category’: ‘sky’, ‘tone’: ‘decrease’, ‘intensity’: ‘mild’ Q: Could you increase the saturation in sky? It looks a bit washed out to me. A: ‘category’: ‘sky’, ‘saturation’: ‘increase’, intensity: ‘mild’ Q: Can you increase the saturation of pet even more than before? A: ‘category’: ‘pets’, ‘saturation’: ‘increase’, ‘intensity’: ‘strong’.” Additionally, prompts 806 may include text such as “Answer the request below using the previous examples. Note, simply answer the request in the example format, do not follow up with additional questions or prepend with extra sentences.”

As another example, prompts 806 may include text such as “We have following categories: Smart Portrait, Bokeh, Panorama, High Frame Rate. Example starts Q: I would like to take picture while focusing face and blurring the background A: mode: ‘Bokeh’ Q: I want slow motion style A: mode: ‘High frame rate’ Example ends Now answer the request below using the previous example(s). Note, simply answer the request in the example format, do not follow up with additional questions or prepend with extra sentences: Q: I want a panoramic view of the wide area.”

In some aspects, LLM 802 may include “fields” for queries, instructions, contextual information, and/or examples. In other cases, system 800 may concatenate prompts 806 with natural-language request 804 to generate a single input to LLM 802.

Returning to FIG. 2A, image-capture components 222 may be capable of capturing image data independent of image-capture settings 220 from adjustment determiner 212. For example, image-capture components 222 may implement autofocus, autoexposure, and/or auto-white balance to capture image data when image-capture components 222 does not receive image-capture settings 220 from adjustment determiner 212. For example, in some cases, for example, when user 202 does not provide a request 204 to camera 206A, camera 206A may bypass, disable, or not use adjustment determiner 212 to determine image-capture settings 220. In such cases, image-capture components 222 may determine image-capture settings, for example, according to autofocus, autoexposure, and/or auto-white balancing.

Similarly, ISP 232 may be capable of processing image data independent of image-processing settings 230 from adjustment determiner 212. For example, when ISP 232 does not receive image-capture settings 220 from adjustment determiner 212, ISP 232 may implement default image-processing techniques and/or image-processing settings or image-processing techniques and/or image-processing settings or based on a mode of camera 206A. For example, in some cases, for example, when user 202 does not provide a request 204 to camera 206A, camera 206A may bypass, disable, or not use adjustment determiner 212 to determine image-processing settings 230. In such cases, ISP 232 may determine or obtain image-processing settings from another source, for example based on a mode of camera 206A.

FIG. 2B is a block diagram illustrating an example system 200B for capturing image data, according to various aspects of the present disclosure.

A user 202 may speak a request 204. A natural-language interface 240 (which may include a speech recognizer, such as speech recognizer 208) may process the spoken request 204 to generate natural-language request 210 (which may be a digital representation of request 204).

A mode/tuning extractor 242 may determine keywords 246 based on natural-language request 210. Mode/tuning extractor 242 may be the same as, may be substantially similar to, and/or may perform the same, or substantially the same, operations as keyword extractor 214 of FIG. 3. Additionally, in some aspects, mode/tuning extractor 242 may determine keywords 246 based on inputs from camera dictionary 244. Camera dictionary 244 may include words related to images, colors, shapes, objects, imaging, cameras, image-capture settings, image-processing settings, image-modification techniques, and other topics. Keywords 246 may be the same as, or may be substantially similar to, as keywords 216 of FIG. 3.

A settings mapper 248 may determine image-capture settings 220 and/or image-processing settings 230 based on keywords 246. Settings mapper 248 may be the same as, may be substantially similar to, and/or may perform the same, or substantially the same, operations as adjustment mapper 218 of FIG. 3.

Control module 250 may determine control signals based on image-capture settings 220 and provide the control signals to image-capture components 252. Image-capture components 252 may include one or more image sensors (e.g., image sensor 254, image sensor 256 and image sensor 258). Control module 250 and image-capture components 252 may cause image sensor 254, image sensor 256, and/or image sensor 258 to capture image data 224 based on image-capture settings 220. For example, control module 250 and/or image-capture components 252 may adjust image-capture settings of image sensor 254, image sensor 256, and/or image sensor 258 based on image-capture settings 220.

An ISP 232 may process image data 224 based on image-processing settings 230 to generate image data 234. A display (not illustrated in FIG. 2B) of camera 206B may display image data 234 (e.g., to user 202). Additionally or alternatively, a memory (not illustrated in FIG. 2B) of camera 206B may store image data 234.

Control module 250 may be capable of determining image-capture settings 220 independent of adjustment determiner 212. For example, control module 250 may implement autofocus, autoexposure, and/or auto-white balance and cause image-capture components 252 to capture image data when control module 250 does not receive image-capture settings 220 from adjustment determiner 212. For example, in some cases, for example, when user 202 does not provide a request 204 to camera 206B, camera 206B may bypass, disable, or not use adjustment determiner 212 to determine image-capture settings 220. In such cases, control module 250 may determine image-capture settings, for example, according to autofocus, autoexposure, and/or auto-white balancing.

Similarly, ISP 232 may be capable of processing image data independent of image-processing settings 230 from adjustment determiner 212. For example, when ISP 232 does not receive image-capture settings 220 from adjustment determiner 212, ISP 232 may implement default image-processing techniques and/or image-processing settings or image-processing techniques and/or image-processing settings or based on a mode of camera 206B. For example, in some cases, for example, when user 202 does not provide a request 204 to camera 206B, camera 206B may bypass, disable, or not use adjustment determiner 212 to determine image-processing settings 230. In such cases, ISP 232 may determine or obtain image-processing settings from another source, for example based on a mode of camera 206B.

FIG. 9 is a block diagram illustrating another example system 900 including LLM 802 for generating keywords 808 based on a natural-language request 804, according to various aspects of the present disclosure. Keywords 808 generated by LLM 802 may be validated by a validator 910. For example, validator 910 may compare keywords 808 to rules to determine if keywords 808 is interpretable by adjustment mapper 218. For example, validator 910 may compare keywords 808 to possible keywords (e.g., words interpretable by adjustment mapper 218). Additionally, validator 910 may compare keywords 808 to a format (e.g., a format interpretable by adjustment mapper 218). If validator 910 determines that keywords 808 is valid, keywords 808 may be the output of system 900.

However, if validator 910 determines that keywords 808 is not valid, validator 910 may provide keywords 808 to LLM 802 with prompts 912, which may include instructions to generate a new instance of keywords 808 based on the prior instance of keywords 808. The prompts 912 may include words and/or formatting instructions. For example, prompts 912 may include text such as “We have following categories: pets, skin, sky, vegetation, flower, hair, clothes, person, all. If we get anything close to these categories, we convert them into closest possible category from the list. Example starts Q: ‘category’: ‘forehead’, ‘details’: ‘increase’, ‘intensity’, ‘strong’ A: ‘category’: ‘skin’, ‘details’: ‘increase’, ‘intensity’, ‘strong’ Q: ‘category’: ‘shirt’, ‘tone’: ‘increase’, ‘intensity’, ‘strong’ A: ‘category’: ‘clothes’, ‘tone’: ‘increase’, ‘intensity’, ‘strong’ Q: ‘category’: ‘car’, ‘contrast’: ‘increase’, ‘intensity’, ‘mild’ A: ‘category’: ‘all’, ‘contrast’: ‘increase’, ‘intensity’, ‘mild’ Q: ‘category’: ‘trees’, ‘tone’: ‘decrease’, ‘intensity’, ‘mild’ A: ‘category’: ‘vegetation’, ‘tone’: ‘decrease’, ‘intensity’, ‘mild’ Q: ‘category’: ‘cat’, ‘saturation’: ‘increase’, ‘intensity’, ‘strong’ A: ‘category’: ‘pet’, ‘saturation’: ‘increase’, ‘intensity’, ‘strong’ Q: ‘category’: ‘rose’, ‘details’: ‘increase’, ‘intensity’, ‘strong’ A: ‘category’: ‘flower’, ‘details’: ‘increase’, ‘intensity’, ‘strong’ Example ends Now convert the following text: Q:”

As an example of operation of system 900, natural-language request 804 may be “Could you fix saturation of trees?” LLM 802 may generate a first instance of keywords 808, the first instance be may “‘category’: ‘trees’, ‘saturation’: ‘increase’, ‘intensity’: ‘mild’.” Validator 910 may determine that “trees” is not a valid category. For example, “trees” may not appear in a list of words interpretable by adjustment mapper 218. Validator 910 may provide the first instance of keywords 808 to LLM 802 along with the example text of prompts 912 provided above. LLM 802 may generate a second instance of keywords 808 based on the first instance of keywords 808 and the example prompts 912. The second instance of keywords 808 may be “‘category’: ‘vegetation’, ‘saturation’: ‘increase’, ‘intensity’: ‘mild.’”

In some aspects, keyword extractor 214 may be, or may include, a vision language model that may be used to generate keywords (e.g., in a specific format) based on natural-language requests. FIG. 10 is a block diagram illustrating an example system 1000 including vision language model (VLM) 1002 for generating keywords 1008 based on a natural-language request 1004, according to various aspects of the present disclosure. VLM 1002 may help camera 206A understand not just the user's request, but also the image/video that is being processed.

VLM 1002 may be an example of keyword extractor 214 of FIG. 2A, natural-language request 1004 may be an example of natural-language request 210 of FIG. 2A, and keywords 1008 may be an example of keywords 216 of FIG. 2A. Image 1006 may be an example of image data 224 of FIG. 2A. In other words, camera 206A may capture image data (e.g., image data 224) and provide the image data to VLM 1002 and VLM 1002 may generate keywords 1008 based on natural-language request 1004 and the provided image data. The provided image data may be preview image data (e.g., capture before the user requests the capture of an image). Alternatively, the provided image may be an image captured in response to a user input (e.g., the user pressing a shutter button or a record button).

VLM 1002 may be trained to generate keywords based on natural-language requests and images. In some aspects, VLM 1002 may be trained to accept and respond to prompts (for example, as described above with regard to LLM 802 of FIG. 8 and FIG. 9).

VLM 1002 may be, or may include, a transformer machine-learning model. Additionally or alternatively, VLM 1002 may include a light-analysis module and/or an image encoder that may output features to a decoder.

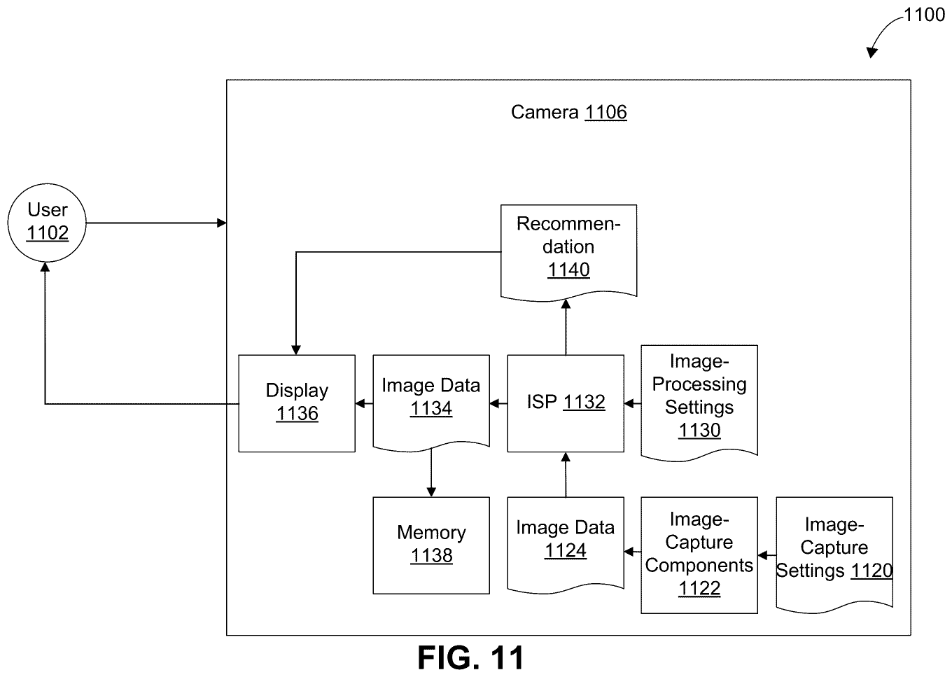

FIG. 11 is a block diagram illustrating an example system 1100 for capturing images, according to various aspects of the present disclosure. In general, user 1102 may use camera 1106 to capture an image. Camera 1106 may determine image-capture settings 1120. In some aspects, camera 1106 may determine image-capture settings 1120 based on a natural-language request, for example, as described with regard to FIG. 11. Image-capture components 1122 may capture image data 1124 based on image-capture settings 1120. Additionally, camera 1106 may determine image-processing settings 1130. In some aspects, camera 1106 may determine image-processing settings 1130 based on a natural-language request, for example, as described with regard to FIG. 11. ISP 1132 may process image data 1124 based on image-processing settings 1130 to generate image data 1134. camera 1106 may display image data 1134 at display 1136. Additionally or alternatively, camera 1106 may store image data 1134 at memory 1138.

Additionally, camera 1106 may analyze image data 1124 (or image data 1134) (e.g., at ISP 1132). Camera 1106 may determine a potentially undesirable aspect of image data 1124. Camera 1106 may generate a recommendation 1140 indicative of a way to correct the potentially undesirable aspect of image data 1124. Camera 1106 may provide request 1104 to user 1102 (e.g., by displaying an indication of recommendation 1140 at display 1136 or using audio data, such as through a speaker).

For example, user 1102 may have composed an image in which the subjects are backlit. User 1102 may, or may not, be aware that the subjects are backlit. Camera 1106, after analyzing the image, may recommend (e.g., by generating and providing recommendation 1140 to user 1102) to user 1102 that the direction in which user 1102 is trying to take picture is backlit and it might help if user 1102 were to rotate a little bit to face the sun.

Camera 1106 may determine recommendation 1140 based on, for example, a determination that a subject of the image is poorly lit, a determination that a subject of the image is backlit, a determination that a subject of the image is occluded, a determination that a subject of the image is centered in the image, and/or a determination that a subject of the image is not centered in the image.

Recommendation 1140 may be, or may include, for example, a recommendation that user 1102 move camera 1106, angle camera 1106, reposition at least one subject of the image, and/or adjust lighting of a scene. Additionally or alternatively, recommendation 1140 may be, or may include, image-capture settings, image-processing settings, image-modification techniques, and/or a mode to use to capture the image.

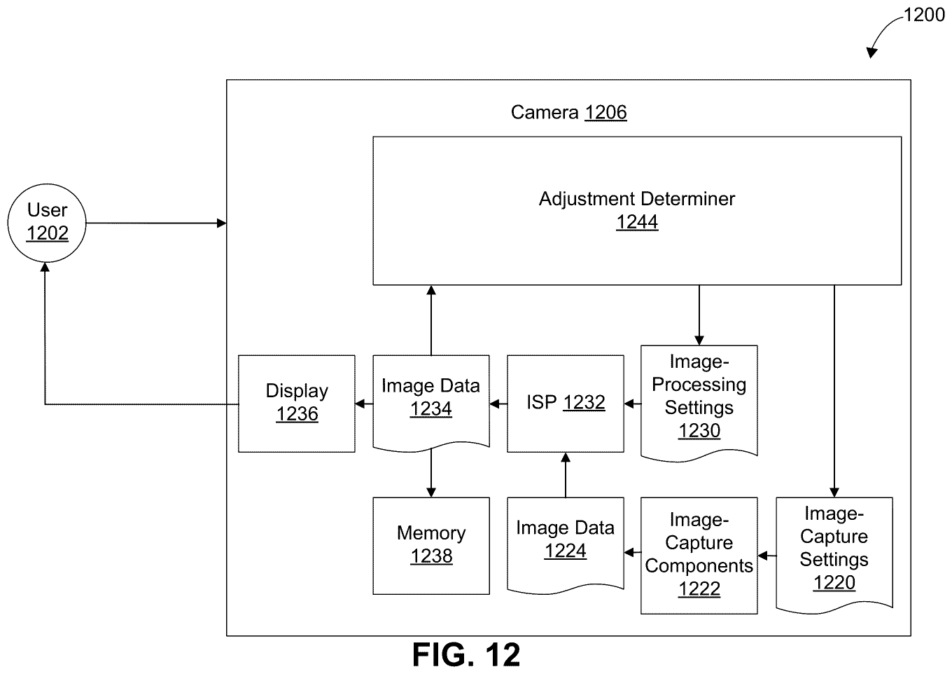

FIG. 12 is a block diagram illustrating an example system 1200 for capturing images, according to various aspects of the present disclosure. In general, user 1202 may use camera 1206 to capture an image. Camera 1206 may determine image-capture settings 1220. In some aspects, camera 1206 may determine image-capture settings 1220 based on a natural-language request, for example, as described with regard to FIG. 12. Image-capture components 1222 may capture image data 1224 based on image-capture settings 1220. Additionally, camera 1206 may determine image-processing settings 1230. In some aspects, camera 1206 may determine image-processing settings 1230 based on a natural-language request, for example, as described with regard to FIG. 12. ISP 1232 may process image data 1224 based on image-processing settings 1230 to generate image data 1234. camera 1206 may display image data 1234 at display 1236. Additionally or alternatively, camera 1206 may store image data 1234 at memory 1238.

Additionally, camera 1206 may analyze image data 1224 (or image data 1234) (e.g., at adjustment determiner 1244) and determine image-capture settings 1220 and/or image-processing settings 1230 based, at least in part, on the analysis of image data 1224. For example, adjustment determiner 1244 may perform facial and/or user recognition on image data 1224 to identify one or more people in image data 1224. Further, adjustment determiner 1244 may determine image-capture settings 1220 and/or image-processing settings 1230 based on the identified person or people.

In some aspects, adjustment determiner 1244 may identify one or more people known to user 1202. For example, adjustment determiner 1244 may have access to person information (e.g., images and/or image features) representative of people known to user 1202. For example, adjustment determiner 1244 may have access to a photo gallery including images of family and friends of user 1202. Adjustment determiner 1244 may identify one or more people known to user 1202 in image data 1224 based on the person information.

Adjustment determiner 1244 may determine image-capture settings 1220 and/or image-processing settings 1230 based on the identified one or more people. Adjustment determiner 1244 may generate image-capture settings 1220 and/or image-processing settings 1230 to prioritize the appearance of the identified one or more people in image data 1224, image data 1234, and/or subsequently-capture images.

For example, adjustment determiner 1244 may identify a person known to user 1202 in a preview image. Adjustment determiner 1244 may determine whether the person is in focus in the preview image and/or whether the person's face is properly exposed in the preview image. Based on the person not being in focus, and/or based on the person not being properly exposed, adjustment determiner 1244 may determine image-capture settings 1220 to capture further images such that in the further images, the person is in focus and properly exposed. Additionally or alternatively, adjustment determiner 1244 may determine image-processing settings 1230 to adjust the preview image and/or subsequently captured images to try to correct the appearance of the person in the preview image and/or subsequently-capture images.

In determining image-capture settings 1220 and/or image-processing settings 1230 based on the identified person, adjustment determiner 1244 may prioritize the appearance of the identified person over the appearance of other people in image data 1224 (e.g., people that were not identified in image data 1224). For example, adjustment determiner 1244 may determine adjustment determiner 1244 such that an identified person is in focus (and/or properly exposed) and an unidentified person in image data 1224 is out of focus and/or improperly exposed.

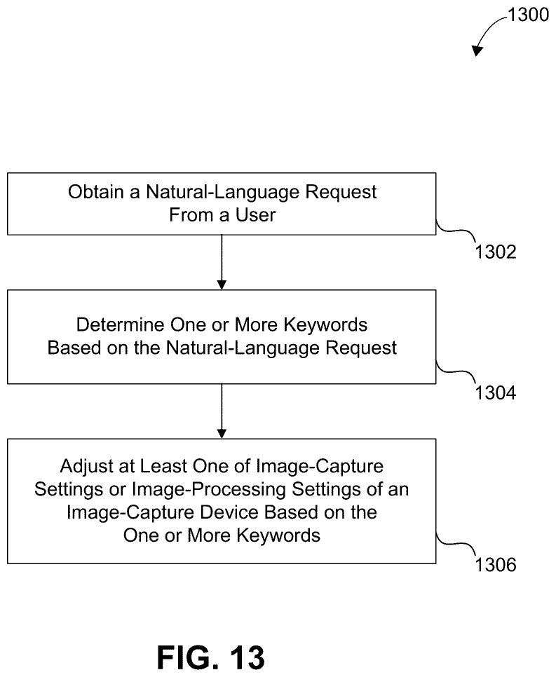

FIG. 13 is a flow diagram illustrating an example process 1300 for capturing images, in accordance with aspects of the present disclosure. One or more operations of process 1300 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1300. The one or more operations of process 1300 may be implemented as software components that are executed and run on one or more processors. For example, process 1300 may be performed by system 200A of FIG. 2A, camera 206A of FIG. 2A, adjustment determiner 212, of FIG. 2A and FIG. 3, FIG. 2A, system 200B of FIG. 2B, camera 206B of FIG. 2B.

At block 1302, a computing device (or one or more components thereof) may obtain a natural-language request from a user. For example, camera 206A may obtain request 204 from user 202.

In some aspects, the computing device (or one or more components thereof) may receive an audio input from the user; and process the audio input using speech recognition to determine the natural-language request. For example, camera 206A may receive request 204 and process request 204 to generate natural-language request 210, for example, at speech recognizer 208.

At block 1304, the computing device (or one or more components thereof) may determine one or more keywords based on the natural-language request. For example, adjustment determiner 212 may determine keywords 216 based on natural-language request 210.

In some aspects, the computing device (or one or more components thereof) may process the natural-language request using a large language model to determine the one or more keywords. For example, keyword extractor 214 may be, or may include, a large language model.

In some aspects, to process the natural-language request using the large language model, the computing device (or one or more components thereof) may provide the large language model with at least one of: contextual information based on at least one of image-capture settings or image-processing settings; instructions for responding to natural-language requests; examples of natural-language requests; examples of keywords; or an output format.

In some aspects, at least one of the examples of keywords or the output format comprises at least two of: an indication of pixels of an image to adjust; an image-capture setting or an image-processing setting to adjust; and an amount by which to adjust the image-capture setting or the image-processing setting.

In some aspects, to process the natural-language request using the large language model, the computing device (or one or more components thereof) may: process the natural-language request using the large language model to generate a first output; compare the first output to possible adjustments; and in response to the first output not matching the possible adjustments, process the first output using the large language model to generate a second output.

In some aspects, the computing device (or one or more components thereof) may process the natural-language request using a small language model to determine the one or more keywords.

In some aspects, the small language model is finetuned based on at least one of image-capture settings or image-processing settings.

In some aspects, the small language model is finetuned to generate keywords indicative of at least two of: an indication of pixels of an image to adjust; an image-capture setting or an image-processing setting to adjust; and an amount by which to adjust the image-capture setting or the image-processing setting.

In some aspects, wherein the small language model is finetuned using outputs generated by a large language model.

In some aspects, to adjust the image-processing settings the at least one processor is configured to: identify pixels of an image to adjust based on the one or more keywords; and adjust values of the pixels according to the one or more keywords.

At block 1306, the computing device (or one or more components thereof) may adjust at least one of image-capture settings or image-processing settings of an image-capture device based on the one or more keywords. For example, adjustment determiner 212 may determine image-capture settings 220 and/or image-processing settings 230 based on keywords 216.

In some aspects, the computing device (or one or more components thereof) may determine an image-capture setting or an image-processing setting to adjust based on the one or more keywords; and determine an amount by which to adjust the image-capture setting or the image-processing setting based on the one or more keywords. For example, adjustment determiner 212 may determine which image-capture settings and/or image-processing settings to adjust and an amount by which to adjust the image-capture settings and/or image-processing settings.

In some aspects, the computing device (or one or more components thereof) may determine pixels of an image to adjust based on the one or more keywords.

In some aspects, to identify the pixels to adjust, the at least one processor is configured to: segment the image to determine associations between pixels of the image and categories; and identify the pixels to adjust based on a match between a category indicated by the one or more keywords and a category of the pixels to adjust.

In some aspects, the computing device (or one or more components thereof) may determine an image-capture mode based on the one or more keywords, wherein the image-capture mode is associated with the at least one of the image-capture settings or the image-processing settings.

In some aspects, the computing device (or one or more components thereof) may at least one of: capture an image according to the image-capture settings; process an image according to the image-processing settings; or modify an image according to the image-processing settings. For example, camera 206A may capture image data 224 based on image-capture settings 220, process image data 224 based on image-processing settings 230, and/or modify image data 224 based on image-processing settings 230.

In some aspects, the computing device (or one or more components thereof) may at least one of: store the image; display the image; transmit the image; or process the image. For example, camera 206A may store image data 234 (e.g., at memory 238), display image data 234 (e.g., at display 236), transmit image data 234, or process image data 234 (e.g., at a machine-learning model).

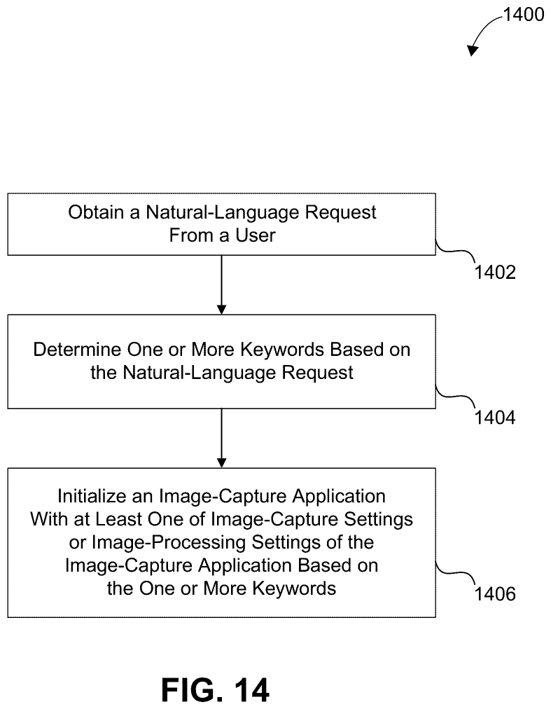

FIG. 14 is a flow diagram illustrating an example process 1400 for capturing images, in accordance with aspects of the present disclosure. One or more operations of process 1400 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1400. The one or more operations of process 1400 may be implemented as software components that are executed and run on one or more processors. For example, process 1400 may be performed by system 200A of FIG. 2A, camera 206A of FIG. 2A, adjustment determiner 212, of FIG. 2A and FIG. 3, FIG. 2A, system 200B of FIG. 2B, camera 206B of FIG. 2B.

At block 1402, a computing device (or one or more components thereof) may obtain a natural-language request from a user.

At block 1404, the computing device (or one or more components thereof) may determine one or more keywords based on the natural-language request.

At block 1406, the computing device (or one or more components thereof) may initialize an image-capture application with at least one of image-capture settings or image-processing settings of the image-capture application based on the one or more keywords.

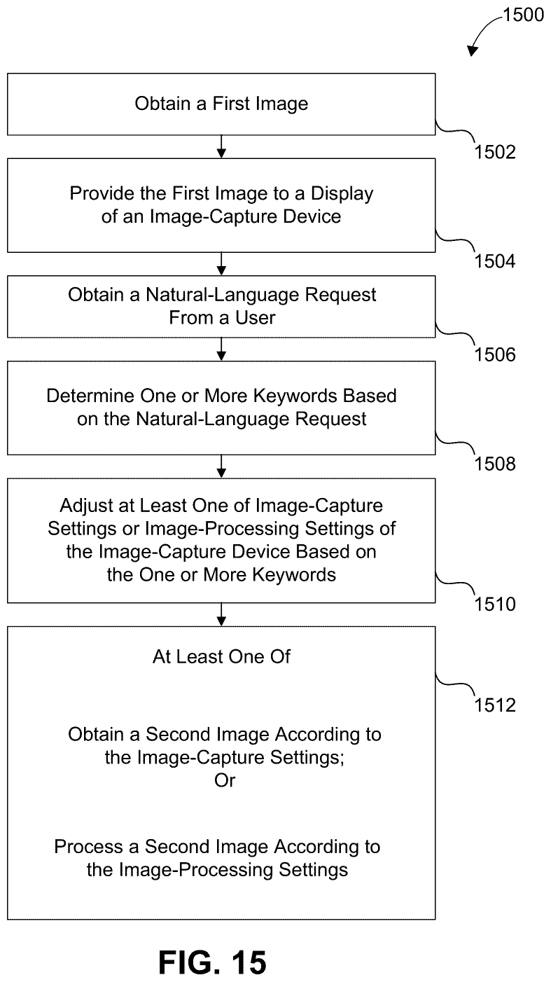

FIG. 15 is a flow diagram illustrating an example process 1500 for capturing images, in accordance with aspects of the present disclosure. One or more operations of process 1500 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1500. The one or more operations of process 1500 may be implemented as software components that are executed and run on one or more processors. For example, process 1500 may be performed by system 200A of FIG. 2A, camera 206A of FIG. 2A, adjustment determiner 212, of FIG. 2A and FIG. 3, system 200B of FIG. 2B, or camera 206B of FIG. 2B.

At block 1502, a computing device (or one or more components thereof) may obtain a first image.

At block 1504, the computing device (or one or more components thereof) may provide the first image to a display of an image-capture device.

At block 1506, the computing device (or one or more components thereof) may obtain a natural-language request from a user.

At block 1508, the computing device (or one or more components thereof) may determine one or more keywords based on the natural-language request.

At block 1510, the computing device (or one or more components thereof) may adjust at least one of image-capture settings or image-processing settings of the image-capture device based on the one or more keywords.

At block 1512, the computing device (or one or more components thereof) may at least one of: obtain a second image according to the image-capture settings; or process a second image according to the image-processing settings.

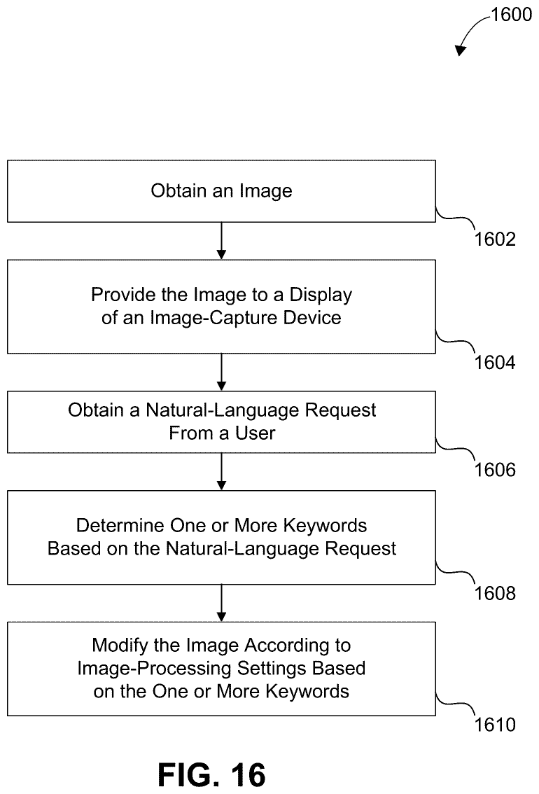

FIG. 16 is a flow diagram illustrating an example process 1600 for capturing images, in accordance with aspects of the present disclosure. One or more operations of process 1600 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1600. The one or more operations of process 1600 may be implemented as software components that are executed and run on one or more processors. For example, process 1600 may be performed by system 200A of FIG. 2A, camera 206A of FIG. 2A, adjustment determiner 212, of FIG. 2A and FIG. 3, system 200B of FIG. 2B, or camera 206B of FIG. 2B.

At block 1602, a computing device (or one or more components thereof) may obtain an image.

At block 1604, the computing device (or one or more components thereof) may provide the image to a display of an image-capture device.

At block 1606, the computing device (or one or more components thereof) may obtain a natural-language request from a user.

At block 1608, the computing device (or one or more components thereof) may determine one or more keywords based on the natural-language request.

At block 1610, the computing device (or one or more components thereof) may modify the image according to image-processing settings based on the one or more keywords.

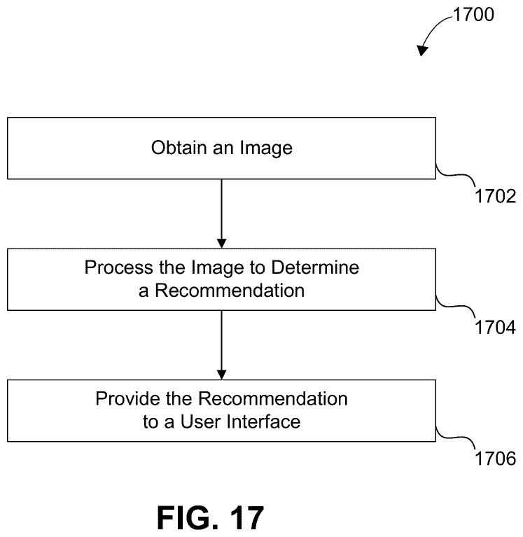

FIG. 17 is a flow diagram illustrating an example process 1700 for capturing images, in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1700. The one or more operations of process 1700 may be implemented as software components that are executed and run on one or more processors. For example, process 1700 may be performed by system 1100 of FIG. 11, camera 1106 of FIG. 11, ISP 1132, of FIG. 11.

At a block 1702, a computing device (or one or more components thereof) may obtain an image.

At a block 1704, the computing device (or one or more components thereof) may process the image to determine a recommendation.

At a block 1706, the computing device (or one or more components thereof) may provide the recommendation to a user interface.

In some aspects, the recommendation may be based on at least one of: a determination that a subject of the image is poorly lit; a determination that a subject of the image is backlit; a determination that a subject of the image is occluded; a determination that a subject of the image is centered in the image; or a determination that a subject of the image is not centered in the image.

In some aspects, the recommendation may be, or may include, a recommendation that a user at least one of: move a camera; angle a camera; reposition at least one subject of the image; or adjust lighting of a scene.

In some aspects, the recommendation may be, or may include, an image-capture mode.

In some aspects, the recommendation may be, or may include, at least one of image-capture settings or image-processing settings.

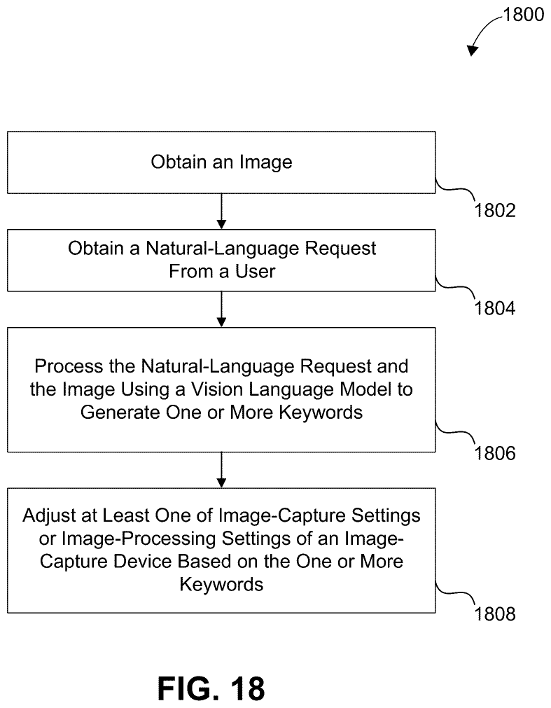

FIG. 18 is a flow diagram illustrating an example process 1800 for capturing images, in accordance with aspects of the present disclosure. One or more operations of process 1800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1800. The one or more operations of process 1800 may be implemented as software components that are executed and run on one or more processors. For example, process 1800 may be performed by system 1000 of FIG. 10, and/or VLM 1002 of FIG. 10.

At block 1802, a computing device (or one or more components thereof) may obtain an image.

At block 1804, the computing device (or one or more components thereof) may obtain a natural-language request from a user.

At block 1806, the computing device (or one or more components thereof) may process the natural-language request and the image using a vision language model to generate one or more keywords.

At block 1808, the computing device (or one or more components thereof) may adjust at least one of image-capture settings or image-processing settings of an image-capture device based on the one or more keywords.

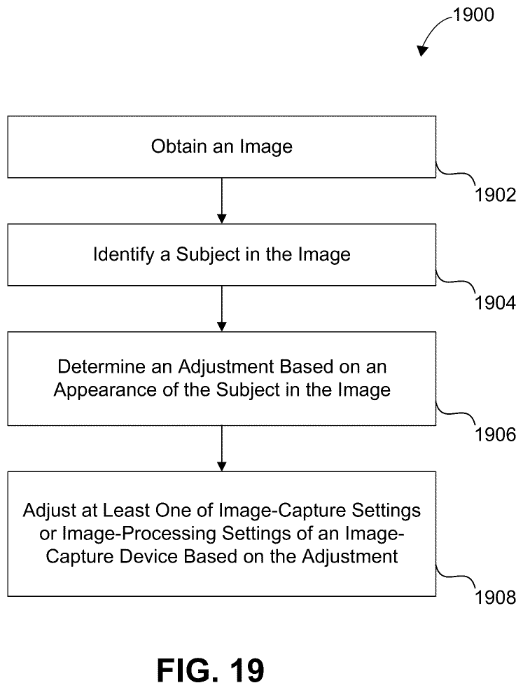

FIG. 19 is a flow diagram illustrating an example process 1900 for capturing images, in accordance with aspects of the present disclosure. One or more operations of process 1900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1900. The one or more operations of process 1900 may be implemented as software components that are executed and run on one or more processors. For example, process 1900 may be performed by system 1200 of FIG. 12, camera 1206 of FIG. 12, and/or adjustment determiner 1244 of FIG. 12.

At block 1902, a computing device (or one or more components thereof) may obtain an image.

At block 1904, the computing device (or one or more components thereof) may identify a subject in the image.

At block 1906, the computing device (or one or more components thereof) may determine an adjustment based on an appearance of the subject in the image.

At block 1908, the computing device (or one or more components thereof) may adjust at least one of image-capture settings or image-processing settings of an image-capture device based on the adjustment.

In some aspects, to identify the image in the subject, the computing device (or one or more components thereof) may process the image using facial recognition to identify the subject.

In some aspects, the facial recognition is based on predetermined people.

In some aspects, the adjustment is to improve the appearance of the subject in the image or in subsequently-captured images, wherein the subsequently-captured images are at least one of captured according to the image-capture settings or processed according to the image-processing settings.

In some aspects, wherein the adjustment comprises at least one of: a focus setting to focus a lens of a camera on the subject; or an exposure setting to properly expose the subject in subsequently-capture images.

In some aspects, wherein the adjustment causes at least one of: the subject to be in focus and an unidentified person in the image to be out of focus; or the subject to be properly exposed and an unidentified person in the image to be either overexposed or underexposed.

In some examples, as noted previously, the methods described herein (e.g., process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19 and/or other methods described herein) can be performed, in whole or in part, by a computing device or apparatus. In one example, one or more of the methods can be performed by system 200A of FIG. 2A, camera 206A of FIG. 2A, adjustment determiner 212 of FIG. 2A, system 200B of FIG. 2B, camera 206B of FIG. 2B, and FIG. 3, system 500 of FIG. 5, system 800 of FIG. 8, system 900 of FIG. 9, system 1000 of FIG. 10, system 1100 of FIG. 11, camera 1106 of FIG. 11, system 1200 of FIG. 12, camera 1206 of FIG. 12, or by another system or device. In another example, one or more of the methods (e.g., process 1300, process 1400, process 1500, process 1600, process 1700, process 1800, process 1900, and/or other methods described herein) can be performed, in whole or in part, by the computing-device architecture 2300 shown in FIG. 23. For instance, a computing device with the computing-device architecture 2300 shown in FIG. 23 can include, or be included in, the components of the system 200A of FIG. 2A, camera 206A of FIG. 2A, adjustment determiner 212 of FIG. 2A and FIG. 3, system 200B of FIG. 2B, camera 206B of FIG. 2B, system 500 of FIG. 5, system 800 of FIG. 8, system 900 of FIG. 9, system 1000 of FIG. 10, system 1100 of FIG. 11, camera 1106 of FIG. 11, system 1200 of FIG. 12, camera 1206 of FIG. 12 and can implement the operations of process 1300, process 1400, process 1500, process 1600, process 1700, process 1800, process 1900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1300, process 1400, process 1500, process 1600, process 1700, process 1800, process 1900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300, process 1400, process 1500, process 1600, process 1700, process 1800, process 1900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

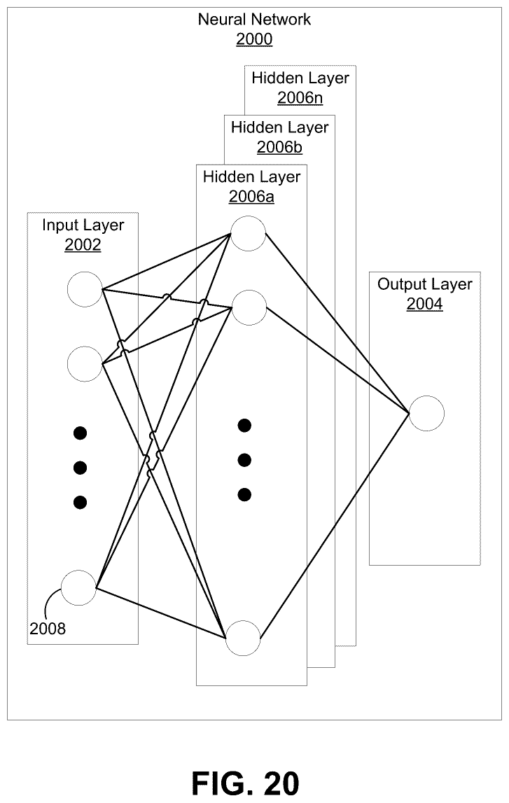

FIG. 20 is an illustrative example of a neural network 2000 (e.g., a deep-learning neural network) that can be used to implement machine-learning based image segmentation, feature segmentation, implicit-neural-representation generation, rendering, classification, object detection, image recognition (e.g., face recognition, object recognition, scene recognition, person recognition, etc.), feature extraction, authentication, gaze detection, gaze prediction, and/or automation. For example, neural network 2000 may be include, or can implement all or part of, SLM 502 of FIG. 5, SLM 602 of FIG. 6, LLM 702 of FIG. 7, LLM 802 of FIG. 8, LLM 902 of FIG. 9, and/or VLM 1002 of FIG. 10.

An input layer 2002 includes input data. In one illustrative example, input layer 2002 can include data representing natural-language request 210 of FIG. 2A, image data 224 of FIG. 4, natural-language request 504 of FIG. 5, input text 606 of FIG. 6, input text 616 of FIG. 6, keywords 704 of FIG. 7, request 714 of FIG. 7, natural-language request 804 of FIG. 8 and FIG. 9, prompts 806 of FIG. 8 and FIG. 9, keywords 808 of FIG. 9, prompts 912 of FIG. 9, natural-language request 1004 of FIG. 10, and/or image 1006 of FIG. 10.

Neural network 2000 includes multiple hidden layers, for example, hidden layers 2006a, 2006b, through 2006n. The hidden layers 2006a, 2006b, through hidden layer 2006n include “n” number of hidden layers, where “n” is an integer greater than or equal to one. The number of hidden layers can be made to include as many layers as needed for the given application. Neural network 2000 further includes an output layer 2004 that provides an output resulting from the processing performed by the hidden layers 2006a, 2006b, through 2006n. In one illustrative example, output layer 2004 can provide image-capture settings 220 and/or image-processing settings 230 of FIG. 2A, classifications 408 of FIG. 4, keywords 506 of FIG. 5, predicted next word 608 of FIG. 6, keywords 618 of FIG. 6, natural-language requests 708 of FIG. 7, natural-language request 718 of FIG. 7, keywords 808 of FIG. 8 and FIG. 9 and/or keywords 1008 of FIG. 10.

Neural network 2000 may be, or may include, a multi-layer neural network of interconnected nodes. Each node can represent a piece of information. Information associated with the nodes is shared among the different layers and each layer retains information as information is processed. In some cases, neural network 2000 can include a feed-forward network, in which case there are no feedback connections where outputs of the network are fed back into itself. In some cases, neural network 2000 can include a recurrent neural network, which can have loops that allow information to be carried across nodes while reading in input.

Information can be exchanged between nodes through node-to-node interconnections between the various layers. Nodes of input layer 2002 can activate a set of nodes in the first hidden layer 2006a. For example, as shown, each of the input nodes of input layer 2002 is connected to each of the nodes of the first hidden layer 2006a. The nodes of first hidden layer 2006a can transform the information of each input node by applying activation functions to the input node information. The information derived from the transformation can then be passed to and can activate the nodes of the next hidden layer 2006b, which can perform their own designated functions. Example functions i convolutional, up-sampling, data transformation, and/or any other suitable functions. The output of the hidden layer 2006b can then activate nodes of the next hidden layer, and so on. The output of the last hidden layer 2006n can activate one or more nodes of the output layer 2004, at which an output is provided. In some cases, while nodes (e.g., node 2008) in neural network 2000 are shown as having multiple output lines, a node has a single output and all lines shown as being output from a node represent the same output value.

In some cases, each node or interconnection between nodes can have a weight that is a set of parameters derived from the training of neural network 2000. Once neural network 2000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 2000 to be adaptive to inputs and able to learn as more and more data is processed.

Neural network 2000 may be pre-trained to process the features from the data in the input layer 2002 using the different hidden layers 2006a, 2006b, through 2006n in order to provide the output through the output layer 2004. In an example in which neural network 2000 is used to identify features in images, neural network 2000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 2000 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 2000 is trained well enough so that the weights of the layers are accurately tuned.

For the example of identifying objects in images, the forward pass can include passing a training image through neural network 2000. The weights are initially randomized before neural network 2000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 2000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 2000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 2000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 2000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 2000 can include any other deep network other than a CNN, such as an autoencoder, a deep belief nets (DBNs), a Recurrent Neural Networks (RNNs), among others.

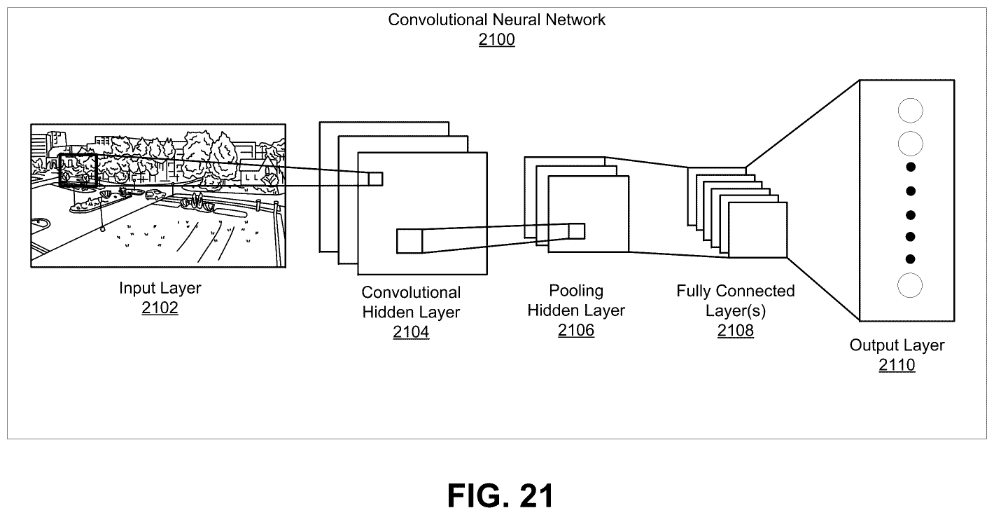

FIG. 21 is an illustrative example of a convolutional neural network (CNN) 2100. The input layer 2102 of the CNN 2100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 2104, an optional non-linear activation layer, a pooling hidden layer 2106, and fully connected layer 2108 (which fully connected layer 2108 can be hidden) to get an output at the output layer 2110. While only one of each hidden layer is shown in FIG. 21, one of ordinary skill will appreciate that multiple convolutional hidden layers, non-linear layers, pooling hidden layers, and/or fully connected layers can be included in the CNN 2100. As previously described, the output can indicate a single class of an object or can include a probability of classes that best describe the object in the image.

The first layer of the CNN 2100 can be the convolutional hidden layer 2104. The convolutional hidden layer 2104 can analyze image data of the input layer 2102. Each node of the convolutional hidden layer 2104 is connected to a region of nodes (pixels) of the input image called a receptive field. The convolutional hidden layer 2104 can be considered as one or more filters (each filter corresponding to a different activation or feature map), with each convolutional iteration of a filter being a node or neuron of the convolutional hidden layer 2104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 2104. Each connection between a node and a receptive field for that node learns a weight and, in some cases, an overall bias such that each node learns to analyze its particular local receptive field in the input image. Each node of the convolutional hidden layer 2104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 2104 is due to each node of the convolutional layer being applied to its corresponding receptive field. For example, a filter of the convolutional hidden layer 2104 can begin in the top-left corner of the input image array and can convolve around the input image. As noted above, each convolutional iteration of the filter can be considered a node or neuron of the convolutional hidden layer 2104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 2104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 2104.

The mapping from the input layer to the convolutional hidden layer 2104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 2104 can include several activation maps in order to identify multiple features in an image. The example shown in FIG. 21 includes three activation maps. Using three activation maps, the convolutional hidden layer 2104 can detect three different kinds of features, with each feature being detectable across the entire image.

In some examples, a non-linear hidden layer can be applied after the convolutional hidden layer 2104. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 2100 without affecting the receptive fields of the convolutional hidden layer 2104.

The pooling hidden layer 2106 can be applied after the convolutional hidden layer 2104 (and after the non-linear hidden layer when used). The pooling hidden layer 2106 is used to simplify the information in the output from the convolutional hidden layer 2104. For example, the pooling hidden layer 2106 can take each activation map output from the convolutional hidden layer 2104 and generates a condensed activation map (or feature map) using a pooling function. Max-pooling is one example of a function performed by a pooling hidden layer. Other forms of pooling functions be used by the pooling hidden layer 2106, such as average pooling, L2-norm pooling, or other suitable pooling functions. A pooling function (e.g., a max-pooling filter, an L2-norm filter, or other suitable pooling filter) is applied to each activation map included in the convolutional hidden layer 2104. In the example shown in FIG. 21, three pooling filters are used for the three activation maps in the convolutional hidden layer 2104.

In some examples, max-pooling can be used by applying a max-pooling filter (e.g., having a size of 2×2) with a stride (e.g., equal to a dimension of the filter, such as a stride of 2) to an activation map output from the convolutional hidden layer 2104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 2104 having a dimension of 24×24 nodes, the output from the pooling hidden layer 2106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 2100.

The final layer of connections in the network is a fully-connected layer that connects every node from the pooling hidden layer 2106 to every one of the output nodes in the output layer 2110. Using the example above, the input layer includes 28×28 nodes encoding the pixel intensities of the input image, the convolutional hidden layer 2104 includes 3×24×24 hidden feature nodes based on application of a 5×5 local receptive field (for the filters) to three activation maps, and the pooling hidden layer 2106 includes a layer of 3×12×12 hidden feature nodes based on application of max-pooling filter to 2×2 regions across each of the three feature maps. Extending this example, the output layer 2110 can include ten output nodes. In such an example, every node of the 3×12×12 pooling hidden layer 2106 is connected to every node of the output layer 2110.

The fully connected layer 2108 can obtain the output of the previous pooling hidden layer 2106 (which should represent the activation maps of high-level features) and determines the features that most correlate to a particular class. For example, the fully connected layer 2108 can determine the high-level features that most strongly correlate to a particular class and can include weights (nodes) for the high-level features. A product can be computed between the weights of the fully connected layer 2108 and the pooling hidden layer 2106 to obtain probabilities for the different classes. For example, if the CNN 2100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 2110 can include an M-dimensional vector (in the prior example, M=10). M indicates the number of classes that the CNN 2100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

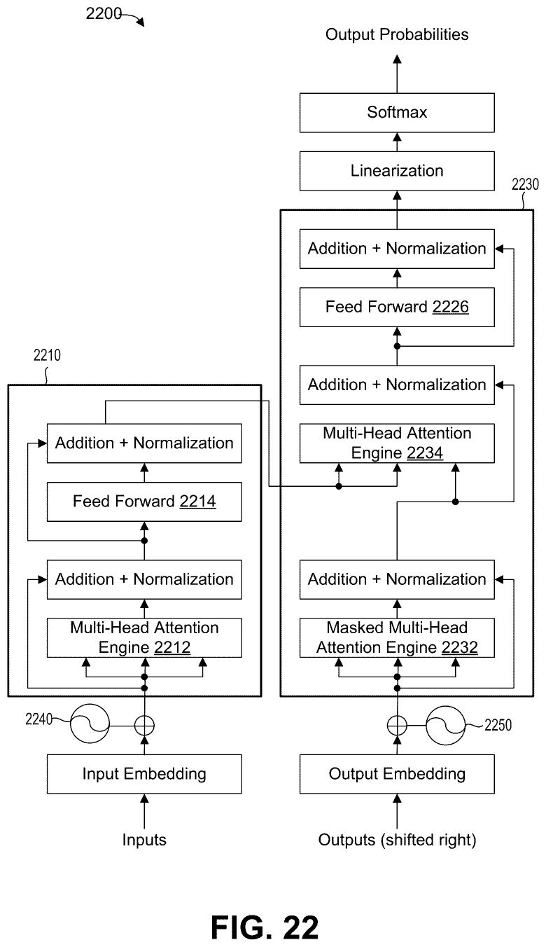

FIG. 22 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 2200 reduces the operations of learning dependencies by using an encoder 2210 and a decoder 2230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 2210 is composed of a stack of six identical layers and each layer has two sub-layers. The first sub-layer is a multi-head self-attention engine 2212, and the second sub-layer is a fully-connected feed-forward network 2214. A residual connection (not shown) connects around each of the sub-layers followed by normalization.

In this example transformer 2200, the decoder 2230 is also composed of a stack of six 6 identical layers. The decoder also includes a masked multi-head self-attention engine 2232, a multi-head attention engine 2234 over the output of the encoder 2210, and a fully-connected feed-forward network 2226. Each layer includes a residual connection (not shown) around the layer, which is followed by layer normalization. The masked multi-head self-attention engine 2232 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 2240 to encode positions because the model does not contain recurrence and convolution and relative or absolute position of the tokens is needed. In the transformer 2200, the positional encodings are added to the input embeddings at the bottom layer of the encoder 2210 and the decoder 2230. The positional encodings are summed with the embeddings because the positional encodings and embeddings have the same dimensions. A corresponding position decoder 2250 is configured to decode the positions of the embeddings for the decoder 2230.

In some aspects, the transformer 2200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 2200 can process input sequences of variable length, making it well-suited for natural language processing tasks where input lengths can vary greatly. Additionally, the self-attention mechanism allows the transformer 2200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 23 illustrates an example computing-device architecture 2300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 2300 may include, implement, or be included in any or all of system 200A of FIG. 2A, camera 206A of FIG. 2A, system 200B of FIG. 2B, camera 206B of FIG. 2B, adjustment determiner 212 of FIG. 2A and FIG. 3, system 500 of FIG. 5, system 800 of FIG. 8, system 900 of FIG. 9, system 1000 of FIG. 10, system 1100 of FIG. 11, camera 1106 of FIG. 11, system 1200 of FIG. 12, camera 1206 of FIG. 12 and/or other devices, modules, or systems described herein. Additionally or alternatively, computing-device architecture 2300 may be configured to perform process 1300 of FIG. 13, process 1400 of FIG. 14, process 1500 of FIG. 15, process 1600 of FIG. 16, process 1700 of FIG. 17, process 1800 of FIG. 18, process 1900 of FIG. 19, and/or other process described herein.

The components of computing-device architecture 2300 are shown in electrical communication with each other using connection 2312, such as a bus. The example computing-device architecture 2300 includes a processing unit (CPU or processor) 2302 and computing device connection 2312 that couples various computing device components including computing device memory 2310, such as read only memory (ROM) 2308 and random-access memory (RAM) 2306, to processor 2302.

Computing-device architecture 2300 can include a cache of high-speed memory connected directly with, in close proximity to, or integrated as part of processor 2302. Computing-device architecture 2300 can copy data from memory 2310 and/or the storage device 2314 to cache 2304 for quick access by processor 2302. In this way, the cache can provide a performance boost that avoids processor 2302 delays while waiting for data. These and other modules can control or be configured to control processor 2302 to perform various actions. Other computing device memory 2310 may be available for use as well. Memory 2310 can include multiple different types of memory with different performance characteristics. Processor 2302 can include any general-purpose processor and a hardware or software service, such as service 1 2316, service 2 2318, and service 3 2320 stored in storage device 2314, configured to control processor 2302 as well as a special-purpose processor where software instructions are incorporated into the processor design. Processor 2302 may be a self-contained system, containing multiple cores or processors, a bus, memory controller, cache, etc. A multi-core processor may be symmetric or asymmetric.

To enable user interaction with the computing-device architecture 2300, input device 2322 can represent any number of input mechanisms, such as a microphone for speech, a touch-sensitive screen for gesture or graphical input, keyboard, mouse, motion input, speech and so forth. Output device 2324 can also be one or more of a number of output mechanisms known to those of skill in the art, such as a display, projector, television, speaker device, etc. In some instances, multimodal computing devices can enable a user to provide multiple types of input to communicate with computing-device architecture 2300. Communication interface 2326 can generally govern and manage the user input and computing device output. There is no restriction on operating on any particular hardware arrangement and therefore the basic features here may easily be substituted for improved hardware or firmware arrangements as they are developed.

Storage device 2314 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 2306, read only memory (ROM) 2308, and hybrids thereof. Storage device 2314 can include services 2316, 2318, and 2320 for controlling processor 2302. Other hardware or software modules are contemplated. Storage device 2314 can be connected to the computing device connection 2312. In one aspect, a hardware module that performs a particular function can include the software component stored in a computer-readable medium in connection with the necessary hardware components, such as processor 2302, connection 2312, output device 2324, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like.

However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. A method for capturing images, the method comprising: obtaining a natural-language request from a user; determining one or more keywords based on the natural-language request; and adjusting at least one of image-capture settings or image-processing settings of an image-capture device based on the one or more keywords.
Aspect 2. The method of aspect 1, further comprising at least one of: capturing an image according to the image-capture settings; processing an image according to the image-processing settings; or modifying an image according to the image-processing settings.
Aspect 3. The method of aspect 2, further comprising at least one of: storing the image; displaying the image; transmitting the image; or processing the image.
Aspect 4. The method of any one of aspects 1 to 3, further comprising: receiving an audio input from the user; and processing the audio input using speech recognition to determine the natural-language request.
Aspect 5. The method of any one of aspects 1 to 4, further comprising: determining an image-capture setting or an image-processing setting to adjust based on the one or more keywords; and determining an amount by which to adjust the image-capture setting or the image-processing setting based on the one or more keywords.
Aspect 6. The method of any one of aspects 1 to 5, further comprising determining pixels of an image to adjust based on the one or more keywords.
Aspect 7. The method of any one of aspects 1 to 6, further comprising determining an image-capture mode based on the one or more keywords, wherein the image-capture mode is associated with the at least one of the image-capture settings or the image-processing settings.
Aspect 8. The method of aspect 7, wherein the image-capture mode comprises at least one of: an expert mode; a professional mode; a professional video mode; a night mode; a food mode; a panorama mode; a slow-motion mode; a time-lapse mode; a portrait mode; a video-portrait mode; a director's view mode; a single-take mode; a sport mode; or a moon-capture mode.
Aspect 9. The method of any one of aspects 1 to 8, wherein the image-capture settings comprise at least one of: a lens; a zoom setting; an exposure duration; an aperture size, a focus setting; an ISO; or a gain setting.
Aspect 10. The method of any one of aspects 1 to 9, wherein the image-processing settings comprise at least one of: an exposure setting; a contrast setting; a highlight setting; a shadow setting; a white-balance setting; an intensity setting; a saturation setting; a sharpness setting; color settings; hue settings; or a noise-reduction setting.
Aspect 11. The method of any one of aspects 1 to 10, wherein the image-processing settings comprise at least one of activation of or parameters for at least one of: a noise-reduction technique; a high-dynamic resolution technique; a super-resolution technique; an artificial bokeh technique; a subject keeper technique; an eraser technique; or a panorama technique.
Aspect 12. The method of any one of aspects 1 to 11, further comprising processing the natural-language request using a large language model to determine the one or more keywords.
Aspect 13. The method of aspect 12, wherein processing the natural-language request using the large language model comprises providing the large language model with at least one of: contextual information based on at least one of image-capture settings or image-processing settings; instructions for responding to natural-language requests; examples of natural-language requests; examples of keywords; or an output format.
Aspect 14. The method of aspect 13, wherein at least one of the examples of keywords or the output format comprises at least two of: an indication of pixels of an image to adjust; an image-capture setting or an image-processing setting to adjust; and an amount by which to adjust the image-capture setting or the image-processing setting.
Aspect 15. The method of any one of aspects 12 to 14, wherein processing the natural-language request using the large language model comprises: processing the natural-language request using the large language model to generate a first output; comparing the first output to possible adjustments; and in response to the first output not matching the possible adjustments, processing the first output using the large language model to generate a second output.
Aspect 16. The method of any one of aspects 1 to 15, further comprising processing the natural-language request using a small language model to determine the one or more keywords.
Aspect 17. The method of aspect 16, wherein the small language model is finetuned based on at least one of image-capture settings or image-processing settings.
Aspect 18. The method of any one of aspects 16 or 17, wherein the small language model is finetuned to generate keywords indicative of at least two of: an indication of pixels of an image to adjust; an image-capture setting or an image-processing setting to adjust; and an amount by which to adjust the image-capture setting or the image-processing setting.
Aspect 19. The method of any one of aspects 16 to 18, wherein the small language model is finetuned using outputs generated by a large language model.
Aspect 20. The method of any one of aspects 1 to 19, wherein adjusting the image-processing settings comprises: identifying pixels of an image to adjust based on the one or more keywords; and adjusting values of the pixels according to the one or more keywords.
Aspect 21. The method of aspect 20, wherein identifying the pixels to adjust comprises: segmenting the image to determine associations between pixels of the image and categories; and identifying the pixels to adjust based on a match between a category indicated by the one or more keywords and a category of the pixels to adjust.
Aspect 22. A method for capturing images, the method comprising: obtaining a natural-language request from a user; determining one or more keywords based on the natural-language request; and initializing an image-capture application with at least one of image-capture settings or image-processing settings of the image-capture application based on the one or more keywords.
Aspect 23. A method for capturing images, the method comprising: obtaining a first image; providing the first image to a display of an image-capture device; obtaining a natural-language request from a user; determining one or more keywords based on the natural-language request; adjusting at least one of image-capture settings or image-processing settings of the image-capture device based on the one or more keywords; and at least one of: obtaining a second image according to the image-capture settings; or processing a second image according to the image-processing settings.
Aspect 24. A method for capturing images, the method comprising: obtaining an image; providing the image to a display of an image-capture device; obtaining a natural-language request from a user; determining one or more keywords based on the natural-language request; and modifying the image according to image-processing settings based on the one or more keywords.
Aspect 25. A method for imaging, the method comprising: obtaining an image; processing the image to determine a recommendation; and providing the recommendation to a user interface.
Aspect 26. The method of aspect 25, wherein the recommendation is based on at least one of: a determination that a subject of the image is poorly lit; a determination that a subject of the image is backlit; a determination that a subject of the image is occluded; a determination that a subject of the image is centered in the image; or a determination that a subject of the image is not centered in the image.
Aspect 27. The method of any one of aspects 25 or 26, wherein the recommendation comprises a recommendation that a user at least one of: move a camera; angle a camera; reposition at least one subject of the image; or adjust lighting of a scene.
Aspect 28. The method of any one of aspects 25 to 27, wherein the recommendation comprises an image-capture mode.
Aspect 29. The method of any one of aspects 25 to 29, wherein the recommendation comprises at least one of image-capture settings or image-processing settings.
Aspect 30. A method for capturing images, the method comprising: obtaining an image; obtaining a natural-language request from a user; processing the natural-language request and the image using a vision language model to generate one or more keywords; and adjusting at least one of image-capture settings or image-processing settings of an image-capture device based on the one or more keywords.
Aspect 31. A method for capturing images, the method comprising: obtaining an image; identifying a subject in the image; determining an adjustment based on an appearance of the subject in the image; and adjusting at least one of image-capture settings or image-processing settings of an image-capture device based on the adjustment.
Aspect 32. The method of aspect 31, wherein identifying the image in the subject comprises processing the image using facial recognition to identify the subject.
Aspect 33. The method of aspect 32, wherein the facial recognition is based on predetermined people.
Aspect 34. The method of any one of aspects 31 to 33, wherein the adjustment is to improve the appearance of the subject in the image or in subsequently-captured images, wherein the subsequently-captured images are at least one of captured according to the image-capture settings or processed according to the image-processing settings.
Aspect 35. The method of any one of aspects 31 to 34, wherein the adjustment comprises at least one of: a focus setting to focus a lens of a camera on the subject; or an exposure setting to properly expose the subject in subsequently-capture images.
Aspect 36. The method of any one of aspects 31 to 35, wherein the adjustment causes at least one of: the subject to be in focus and an unidentified person in the image to be out of focus; or the subject to be properly exposed and an unidentified person in the image to be either overexposed or underexposed.
Aspect 37. An apparatus for capturing images, the apparatus comprising: at least one memory; and at least one processor coupled to the at least one memory and configured to: obtain a natural-language request from a user; determine one or more keywords based on the natural-language request; and determine at least one adjustment to at least one of image-capture settings or image-processing settings of an image-capture device based on the one or more keywords.
Aspect 38. The apparatus of aspect 37, wherein the at least one processor is configured to provide the at least one adjustment to a control module.
Aspect 39. The apparatus of aspect 38, wherein the control module is configured to control at least one of: focus; exposure; or white balance.
Aspect 40. The apparatus of any one of aspects 37 to 39, wherein the control module is configured to implement at least one of: autofocus; autoexposure; or auto-white balance.
Aspect 41. The apparatus of any one of aspects 38 to 40, wherein the at least one processor is configured to provide the at least one adjustment to an image signal processor (ISP).
Aspect 42. The apparatus of aspect 41, wherein the ISP is configured to process images.
Aspect 43. The apparatus of any one of aspects 37 to 42, further comprising a control module configured to control at least one of: focus; exposure; or white balance.
Aspect 44. The apparatus of any one of aspects 37 to 43, further comprising image signal processor (ISP) configured to process images.
Aspect 45. An apparatus for capturing images, the apparatus comprising: at least one memory; and at least one processor coupled to the at least one memory and configured to: obtain a natural-language request from a user; determine one or more keywords based on the natural-language request; and adjust at least one of image-capture settings or image-processing settings of an image-capture device based on the one or more keywords.
Aspect 46. The apparatus of aspect 45, wherein the at least one processor is configured to at least one of: capture an image according to the image-capture settings; process an image according to the image-processing settings; or modify an image according to the image-processing settings.
Aspect 47. The apparatus of aspect 46, wherein the at least one processor is configured to at least one of: store the image; display the image; transmit the image; or process the image.
Aspect 48. The apparatus of any one of aspects 45 to 47, wherein the at least one processor is configured to: receive an audio input from the user; and process the audio input using speech recognition to determine the natural-language request.
Aspect 49. The apparatus of any one of aspects 45 to 48, wherein the at least one processor is configured to: determine an image-capture setting or an image-processing setting to adjust based on the one or more keywords; and determine an amount by which to adjust the image-capture setting or the image-processing setting based on the one or more keywords.
Aspect 50. The apparatus of any one of aspects 45 to 49, wherein the at least one processor is configured to determine pixels of an image to adjust based on the one or more keywords.
Aspect 51. The apparatus of any one of aspects 45 to 50, wherein the at least one processor is configured to determine an image-capture mode based on the one or more keywords, wherein the image-capture mode is associated with the at least one of the image-capture settings or the image-processing settings.
Aspect 52. The apparatus of aspect 51, wherein the image-capture mode comprises at least one of: an expert mode; a professional mode; a professional video mode; a night mode; a food mode; a panorama mode; a slow-motion mode; a time-lapse mode; a portrait mode; a video-portrait mode; a director's view mode; a single-take mode; a sport mode; or a moon-capture mode.
Aspect 53. The apparatus of any one of aspects 45 to 52, wherein the image-capture settings comprise at least one of: a lens; a zoom setting; an exposure duration; an aperture size, a focus setting; an ISO; or a gain setting.
Aspect 54. The apparatus of any one of aspects 45 to 53, wherein the image-processing settings comprise at least one of: an exposure setting; a contrast setting; a highlight setting; a shadow setting; a white-balance setting; an intensity setting; a saturation setting; a sharpness setting; color settings; hue settings; or a noise-reduction setting.
Aspect 55. The apparatus of any one of aspects 45 to 54, wherein the image-processing settings comprise at least one of activation of or parameters for at least one of: a noise-reduction technique; a high-dynamic resolution technique; a super-resolution technique; an artificial bokeh technique; a subject keeper technique; an eraser technique; or a panorama technique.
Aspect 56. The apparatus of any one of aspects 45 to 55, wherein the at least one processor is configured to process the natural-language request using a large language model to determine the one or more keywords.
Aspect 57. The apparatus of aspect 56, wherein processing the natural-language request using the large language model comprises providing the large language model with at least one of: contextual information based on at least one of image-capture settings or image-processing settings; instructions for responding to natural-language requests; examples of natural-language requests; examples of keywords; or an output format.
Aspect 58. The apparatus of aspect 57, wherein at least one of the examples of keywords or the output format comprises at least two of: an indication of pixels of an image to adjust; an image-capture setting or an image-processing setting to adjust; and an amount by which to adjust the image-capture setting or the image-processing setting.
Aspect 59. The apparatus of any one of aspects 56 to 58, wherein, to process the natural-language request using the large language model, the at least one processor is configured to: process the natural-language request using the large language model to generate a first output; compare the first output to possible adjustments; and in response to the first output not matching the possible adjustments, process the first output using the large language model to generate a second output.
Aspect 60. The apparatus of any one of aspects 45 to 59, wherein the at least one processor is configured to process the natural-language request using a small language model to determine the one or more keywords.
Aspect 61. The apparatus of aspect 60, wherein the small language model is finetuned based on at least one of image-capture settings or image-processing settings.
Aspect 62. The apparatus of any one of aspects 60 or 61, wherein the small language model is finetuned to generate keywords indicative of at least two of: an indication of pixels of an image to adjust; an image-capture setting or an image-processing setting to adjust; and an amount by which to adjust the image-capture setting or the image-processing setting.
Aspect 63. The apparatus of any one of aspects 60 to 62, wherein the small language model is finetuned using outputs generated by a large language model.
Aspect 64. The apparatus of any one of aspects 45 to 63, wherein, to adjust the image-processing settings the at least one processor is configured to: identify pixels of an image to adjust based on the one or more keywords; and adjust values of the pixels according to the one or more keywords.
Aspect 65. The apparatus of aspect 64, wherein, to identify the pixels to adjust, the at least one processor is configured to: segment the image to determine associations between pixels of the image and categories; and identify the pixels to adjust based on a match between a category indicated by the one or more keywords and a category of the pixels to adjust.
Aspect 66. An apparatus for capturing images, the apparatus comprising: at least one memory; and at least one processor coupled to the at least one memory and configured to: obtain a natural-language request from a user; determine one or more keywords based on the natural-language request; and initialize an image-capture application with at least one of image-capture settings or image-processing settings of the image-capture application based on the one or more keywords.
Aspect 67. An apparatus for capturing images, the apparatus comprising: at least one memory; and at least one processor coupled to the at least one memory and configured to: obtain a first image; provide the first image to a display of an image-capture device; obtain a natural-language request from a user; determine one or more keywords based on the natural-language request; adjust at least one of image-capture settings or image-processing settings of the image-capture device based on the one or more keywords; and at least one of: obtain a second image according to the image-capture settings; or process a second image according to the image-processing settings.
Aspect 68. An apparatus for capturing images, the apparatus comprising: at least one memory; and at least one processor coupled to the at least one memory and configured to: obtain an image; provide the image to a display of an image-capture device; obtain a natural-language request from a user; determine one or more keywords based on the natural-language request; and modify the image according to image-processing settings based on the one or more keywords.
Aspect 69. An apparatus for imaging, the apparatus comprising: at least one memory; and at least one processor coupled to the at least one memory and configured to: obtain an image; process the image to determine a recommendation; and provide the recommendation to a user interface.
Aspect 70. The apparatus of aspect 69, wherein the recommendation is based on at least one of: a determination that a subject of the image is poorly lit; a determination that a subject of the image is backlit; a determination that a subject of the image is occluded; a determination that a subject of the image is centered in the image; or a determination that a subject of the image is not centered in the image.
Aspect 71. The apparatus of any one of aspects 69 or 70, wherein the recommendation comprises a recommendation that a user at least one of: move a camera; angle a camera; reposition at least one subject of the image; or adjust lighting of a scene.
Aspect 72. The apparatus of any one of aspects 69 to 71, wherein the recommendation comprises an image-capture mode.
Aspect 73. The apparatus of any one of aspects 69 to 72, wherein the recommendation comprises at least one of image-capture settings or image-processing settings.
Aspect 74. An apparatus for capturing images, the apparatus comprising: at least one memory; and at least one processor coupled to the at least one memory and configured to: obtain an image; obtain a natural-language request from a user; process the natural-language request and the image using a vision language model to generate one or more keywords; and adjust at least one of image-capture settings or image-processing settings of an image-capture device based on the one or more keywords.
Aspect 75. An apparatus for capturing images, the apparatus comprising: at least one memory; and at least one processor coupled to the at least one memory and configured to: obtain an image; identify a subject in the image; determine an adjustment based on an appearance of the subject in the image; and adjust at least one of image-capture settings or image-processing settings of an image-capture device based on the adjustment.
Aspect 76. The apparatus of aspect 75, wherein, to identify the image in the subject, the at least one processor is configured to process the image using facial recognition to identify the subject.
Aspect 77. The apparatus of aspect 76, wherein the facial recognition is based on predetermined people.
Aspect 78. The apparatus of any one of aspects 75 to 77, wherein the adjustment is to improve the appearance of the subject in the image or in subsequently-captured images, wherein the subsequently-captured images are at least one of captured according to the image-capture settings or processed according to the image-processing settings.
Aspect 79. The apparatus of any one of aspects 75 to 78, wherein the adjustment comprises at least one of: a focus setting to focus a lens of a camera on the subject; or an exposure setting to properly expose the subject in subsequently-capture images.
Aspect 80. The apparatus of any one of aspects 75 to 79, wherein the adjustment causes at least one of: the subject to be in focus and an unidentified person in the image to be out of focus; or the subject to be properly exposed and an unidentified person in the image to be either overexposed or underexposed.
Aspect 81. A non-transitory computer-readable storage medium having stored thereon instructions that, when executed by at least one processor, cause the at least one processor to perform operations according to any of aspects 1 to 36.
Aspect 82. An apparatus for providing virtual content for display, the apparatus comprising one or more means for perform operations according to any of aspects 1 to 36.

What is claimed is:

1. An apparatus for capturing images, the apparatus comprising:
at least one memory; and
at least one processor coupled to the at least one memory and configured to:
obtain a natural-language request from a user;
determine one or more keywords based on the natural-language request; and
adjust at least one of image-capture settings or image-processing settings of an image-capture device based on the one or more keywords.

2. The apparatus of claim 1, wherein the at least one processor is configured to:
receive an audio input from the user; and
process the audio input using speech recognition to determine the natural-language request.

3. The apparatus of claim 1, wherein the at least one processor is configured to:
determine an image-capture setting or an image-processing setting to adjust based on the one or more keywords; and
determine an amount by which to adjust the image-capture setting or the image-processing setting based on the one or more keywords.

4. The apparatus of claim 1, wherein the at least one processor is configured to determine pixels of an image to adjust based on the one or more keywords.

5. The apparatus of claim 1, wherein the at least one processor is configured to:
segment the image to determine associations between pixels of the image and categories;
identify pixels to adjust based on a match between a category indicated by the one or more keywords and a category of the pixels to adjust; and
adjust values of the pixels according to the one or more keywords.

6. The apparatus of claim 1, wherein the at least one processor is configured to determine an image-capture mode based on the one or more keywords, wherein the image-capture mode is associated with the at least one of the image-capture settings or the image-processing settings.

7. The apparatus of claim 1, wherein, to determine the one or more keywords based on the natural-language request, the at least one processor is configured to:
process the natural-language request using a language model to generate a first output;
compare the first output to possible adjustments; and
in response to the first output not matching the possible adjustments, process the first output using the language model to generate a second output.

8. The apparatus of claim 7, wherein the language model is finetuned based on at least one of image-capture settings or image-processing settings.

9. The apparatus of claim 7, wherein the language model is finetuned to generate keywords indicative of at least two of:
an indication of pixels of an image to adjust;
an image-capture setting or an image-processing setting to adjust; and
an amount by which to adjust the image-capture setting or the image-processing setting.

10. The apparatus of claim 1, wherein the at least one processor is configured to at least one of:
capture an image according to the image-capture settings;
process an image according to the image-processing settings; or
modify an image according to the image-processing settings.

11. The apparatus of claim 10, wherein the at least one processor is configured to at least one of:
store the image;
display the image;
transmit the image; or
process the image.

12. The apparatus of claim 1, wherein the at least one processor is configured to:
obtain an image;
process the image to determine a recommendation; and
provide the recommendation to a user interface.

13. The apparatus of claim 1, wherein the at least one processor is configured to:
obtain an image;
identify a subject in the image;
determine an adjustment based on an appearance of the subject in the image; and
adjust at least one of image-capture settings or image-processing settings of the image-capture device based on the adjustment.

14. An apparatus for capturing images, the apparatus comprising:
at least one memory; and
at least one processor coupled to the at least one memory and configured to:
cause an image-capture device to capture a first image according to first image-capture settings;
cause a display to display the first image;
obtain a natural-language request from a user;
determine one or more keywords based on the natural-language request;
adjust the first image-capture settings based on the one or more keywords to generate second image-capture settings; and
cause the image-capture device to capture a second image according to the second image-capture settings.

15. The apparatus of claim, 14, wherein the at least one processor is configured to:
prior to causing the display to display the first image, process the first image according to first image-processing settings;
adjust the first image-processing settings based on the one or more keywords to generate second image-processing settings; and
process the second image according to the second image-processing settings.

16. A method for capturing images, the method comprising:
obtaining a natural-language request from a user;
determining one or more keywords based on the natural-language request; and
adjusting at least one of image-capture settings or image-processing settings of an image-capture device based on the one or more keywords.

17. The method of claim 16, further comprising:
receiving an audio input from the user; and
processing the audio input using speech recognition to determine the natural-language request.

18. The method of claim 16, further comprising:
determining an image-capture setting or an image-processing setting to adjust based on the one or more keywords; and
determining an amount by which to adjust the image-capture setting or the image-processing setting based on the one or more keywords.

19. The method of claim 16, further comprising determining pixels of an image to adjust based on the one or more keywords.

20. The method of claim 16, further comprising:
segmenting the image to determine associations between pixels of the image and categories;
identifying pixels to adjust based on a match between a category indicated by the one or more keywords and a category of the pixels to adjust; and
adjusting values of the pixels according to the one or more keywords.
